(19) United States
(12) Patent Application Publication
(10) Pub. No.: US 2012/0221966 A1
(43) Pub. Date: Aug. 30, 2012

(54) MOBILE ELECTRONIC DEVICE

(75) Inventors: Akiko INAMI, Anpachi-gun (JP); Takashi SUGIYAMA, Anpachi-gun (JP)

(73) Assignee: KYOCERA CORPORATION, Kyoto (JP)

(21) Appl. No.: 13/403,819

(22) Filed: Feb. 23, 2012

(30) Foreign Application Priority Data
Feb. 24, 2011 (JP) 2011-038719

(51) Int. Cl. G06F 3/01

(52) U.S. Cl. 715/761

(57) ABSTRACT

Mobile electronic devices and methods are disclosed. A plurality of display modules simultaneously visible, and at least one of the display modules displays an icon for starting up an application program. A memory stores a first application program for which startup is possible through a plurality of startup methods, each of the startup methods uses a respective display module for execution of the first application program from among the display modules. A control module displays a first icon for starting up the first application program on the at least one of the display modules in a plurality of display modes respectively associated with the startup methods. An application-program execution module starts up the first application program using the startup methods associated with a display mode of the first icon in response to an operation issuing an instruction to start up the first application program associated with the first icon.

### CROSS-REFERENCE TO RELATED APPLICATION

The present application claims priority under 35 U.S.C. §119 to Japanese Patent Application No. 2011-038719, filed on Feb. 24, 2011, entitled “ELECTRONIC DEVICE”. The content of which is incorporated by reference herein in its entirety.

### FIELD

Embodiments of the present disclosure relate generally to mobile electronic devices, and more particularly relate to mobile electronic device comprising more than one display screen thereon.

### BACKGROUND

Some mobile phones comprise multiple display screens that are visible simultaneously. In a mobile phone, multiple application programs may be stored. In a mobile phone comprising multiple display screens that are visible simultaneously, depending on the application program, abuser may not be able to select the display screen used for execution at a time of activation of the application program.

### SUMMARY

Mobile electronic devices and methods are disclosed. A plurality of display modules simultaneously visible, and at least one of the display modules displays an icon for starting up an application program. A memory stores a first application program for which startup is possible through a plurality of startup methods, each of the startup methods uses a respective display module for execution of the first application program from among the display modules.

A control module displays a first icon for starting up the first application program on the at least one of the display modules in a plurality of display modes respectively associated with the startup methods. An application-program execution module starts up the first application program using the startup methods associated with a display mode of the first icon in response to an operation issuing an instruction to start up the first application program associated with the first icon.

In this manner, a user is able to select display screen used for execution at a time of activation of the application program.

In an embodiment, a mobile electronic device comprises: a plurality of display modules simultaneously visible, a memory, a control module, and an application-program. At least one of the display modules that are simultaneously visible displays an icon for starting up an application program. The memory stores a first application program for which startup is possible through a plurality of startup methods, each of the startup methods uses a respective display module for execution of the first application program from among the display modules. The control module displays a first icon for starting up the first application program on the at least one of the display modules in a plurality of display modes respectively associated with the startup methods. Further, the application program execution module starts the first application program using the startup methods associated with a display mode of the first icon in response to an operation issuing an instruction to start up the first application program associated with the first icon.

In another embodiment, a mobile electronic device comprises: a plurality of display modules simultaneously visible, a memory, a control module, and an application-program. At least one of the display modules that are simultaneously visible displays an icon for starting up an application program together with identification information for identifying a type of application program associated with the icon. The memory stores a first application program that is started up through a plurality of startup methods that are different in each of the display modules used in an execution of an application program from among the display modules. The control module changes over time a display mode of the identification information between the display modes respectively associated with the startup methods and display the identification information together with the icon. The application-program execution module starts up the first application program with the startup method associated with the display mode of the identification information in response to an operation issuing an instruction to start up a first application program associated with the icon.

In a further embodiment, a mobile electronic device comprises: a plurality of display screens simultaneously visible, a memory, a control module, and an application-program. At least one of the display screens that are simultaneously visible displays an icon for starting up an application program. The memory stores a first type of application program for which startup is possible through a plurality of startup methods each of the methods use a different display module for an execution of the application program from among the display modules, and a plurality of startup instruction operations that are performed on a first icon for starting up the first type of application and that are respectively associated with the startup methods as operations issuing instructions to start up the first type of application. The application-program execution module starts up the application program associated with the first program based on the startup method associated with the startup instruction operation, when a startup instruction operation is performed on the first icon.

In a further embodiment a method for operating a mobile electronic device, displays a startup icon for starting an application program that starts through a plurality of startup methods each using a respective display module from among a plurality of display modules for execution of the application program. The method also displays the startup icon on at least one of the display modules in at least one of a plurality of display modes respectively associated with the startup methods. The method further starts the application program using a startup method among the startup methods associated with a display mode of the startup icon among the display modes in response to an operation issuing an instruction to start up the application program associated with the startup icon.

In a further embodiment, a computer readable storage medium comprising computer-executable instructions for operating a mobile electronic device. The method executed by the computer-executable instructions displays a startup icon for starting an application program that starts through a plurality of startup methods each using a respective display module from among a plurality of display modules for execution of the application program. The method executed by the computer-executable instructions further displays the startup icon on at least one of the display modules in at least one of a plurality of display modes respectively associated with the startup methods. The method executed by the computer-executable instructions also starts the application program using a startup method among the startup methods associated with a display mode of the startup icon among the display modes in response to an operation issuing an instruction to start up the application program associated with the startup icon.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is a diagram showing mobile phone in a closed state when viewed from the first chassis according to an embodiment of the disclosure.

FIG. 2 is a diagram showing a mobile phone in a closed state when viewed from the second chassis according to an embodiment of the disclosure.

FIG. 3 shows the mobile phone of FIG. 1 in an open state according to an embodiment of the disclosure.

FIG. 4 shows the mobile phone of FIG. 1 in an open state according to an embodiment of the disclosure.

FIG. 5 is a functional block diagram of a mobile phone according to an embodiment of the disclosure.

FIG. 6 is a diagram showing an exemplary home screen displayed by a mobile phone in an open state according to an embodiment of the disclosure.

FIG. 7 is a diagram showing an exemplary display of a mobile phone according to an embodiment of the disclosure.

FIG. 8 is a diagram showing icons displayed by a mobile phone according to an embodiment of the disclosure.

FIG. 9 is a diagram showing exemplary displays of a mobile phone according to an embodiment of the disclosure.

FIG. 10 is a diagram showing example displays of the mobile phone according to an embodiment of the disclosure.

FIG. 11 is a diagram showing a startup instruction operation performed on a mobile phone according to an embodiment of the disclosure.

FIG. 12 is a diagram showing an example display of the mobile phone according to an embodiment of the disclosure.

FIG. 13 is a diagram showing an example display of the mobile phone according to an embodiment of the disclosure.

FIG. 14 is a diagram showing a startup instruction operation performed on the mobile phone according to an embodiment of the disclosure.

FIG. 15 is a diagram showing example displays of the mobile phone according to an embodiment of the disclosure.

FIG. 16 is a diagram showing example displays of the mobile phone according to an embodiment of the disclosure.

FIG. 17 is a diagram showing example displays of the mobile phone according to an embodiment of the disclosure.

FIG. 18 is a diagram showing example displays of the mobile phone according to an embodiment of the disclosure.

FIG. 19 is a diagram showing icons displayed on the mobile phone according to an embodiment of the disclosure.

FIG. 20 is a diagram showing an example display of the mobile phone according to an embodiment of the disclosure.

FIG. 21 is a diagram showing an example of a screen displayed during the execution of an alarm application when the alarm application, which is a type A application, has been started up with the first one-screen startup method to according an embodiment of the disclosure.

FIG. 22 is a diagram showing an example of a screen displayed during an execution of an alarm application when the alarm application has been started up with a second one-screen startup method to according an embodiment of the disclosure.

FIG. 23 is a diagram showing icons displayed by a mobile phone according an embodiment of the disclosure.

FIG. 24 is a diagram showing a color of an icon 300B for type B startup for starting up an E-mail application according an embodiment of the disclosure.

FIG. 25 is a diagram showing an outline of an icon 300B for type B startup for starting up an E-mail application changing between dissimilar shapes according an embodiment of the disclosure.

FIG. 26 is a diagram showing an outline of an icon 300B for type B startup for starting up an E-mail application changing between dissimilar shapes according an embodiment of the disclosure.

FIG. 27 is a diagram showing an icon 300B for type B startup for starting up an E-mail application rotating according an embodiment of the disclosure.

FIG. 28 is a diagram showing an icon 300B for type B startup for starting up an E-mail application rotating according an embodiment of the disclosure.

FIG. 29 is a diagram showing startup instruction operations performed on an mobile according an embodiment of the disclosure.

FIG. 30 is a diagram showing startup instruction operations performed on a mobile according an embodiment of the disclosure.

FIG. 31 is a diagram showing an example display of a mobile phone according to according an embodiment of the disclosure.

FIG. 32 is a diagram showing an example display of a mobile phone according an embodiment of the disclosure.

FIG. 33 is a diagram showing an example display of a mobile phone according an embodiment of the disclosure.

FIG. 34 is an example display of a mobile phone according an embodiment of the disclosure.

FIG. 35 is an example display of the mobile phone according to an embodiment of the disclosure.

FIG. 36 is a diagram showing startup instruction operations performed on a mobile phone according to an embodiment.

FIG. 37 is a diagram showing startup instruction operations performed on a mobile phone according to an embodiment of the disclosure.

FIG. 38 is a diagram showing example displays of a mobile phone according to an embodiment of the disclosure.

FIG. 39 is a diagram showing example displays of a mobile phone according to an embodiment of the disclosure.

FIG. 40 is a diagram showing example displays of a mobile phone according to an embodiment of the disclosure.

FIG. 41 is a diagram showing flicks being performed on icons 300B for type B startup according to an embodiment of the disclosure.

FIG. 42 is a diagram showing flicks being performed on icons 300B for type B startup according to an embodiment of the disclosure.

FIG. 43 is a diagram showing flicks being performed on icons 300B for type B startup according to an embodiment of the disclosure.

FIG. 44 is a diagram showing flicks being performed on icons 300B for type B startup according to an embodiment of the disclosure.

FIG. 45 is a diagram showing example displays of a mobile phone according to an embodiment of the disclosure.

FIG. 46 is a diagram showing example displays of a mobile phone according to an embodiment of the disclosure.

FIG. 47 is a diagram showing example displays of a mobile phone according to an embodiment of the disclosure.

FIG. 48 is a diagram showing an example display on a mobile phone according to an embodiment of the disclosure.

FIG. 49 is a diagram showing an example display of a mobile phone according to an embodiment of the disclosure.

FIG. 50 is a diagram showing an example display of a mobile phone according to an embodiment of the disclosure.

FIG. 51 is a diagram showing a functional block diagram of a mobile phone according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, Global Positioning Systems (GPSs) or navigation systems, health equipment, display monitors, e-books, or other electronic device that uses a display screen or a touch panel for displaying information.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

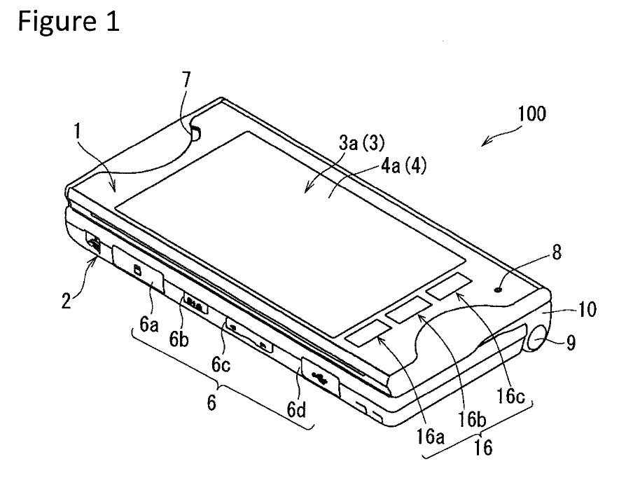

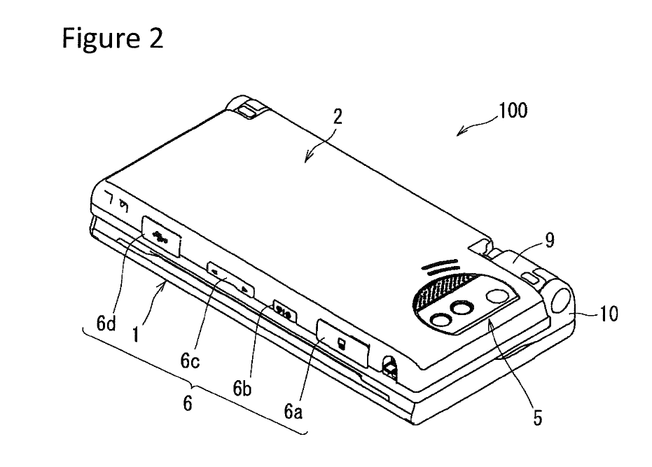

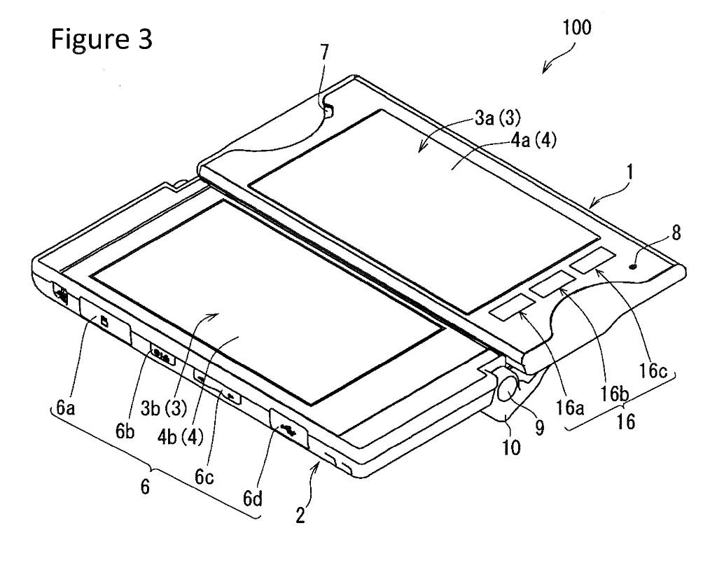

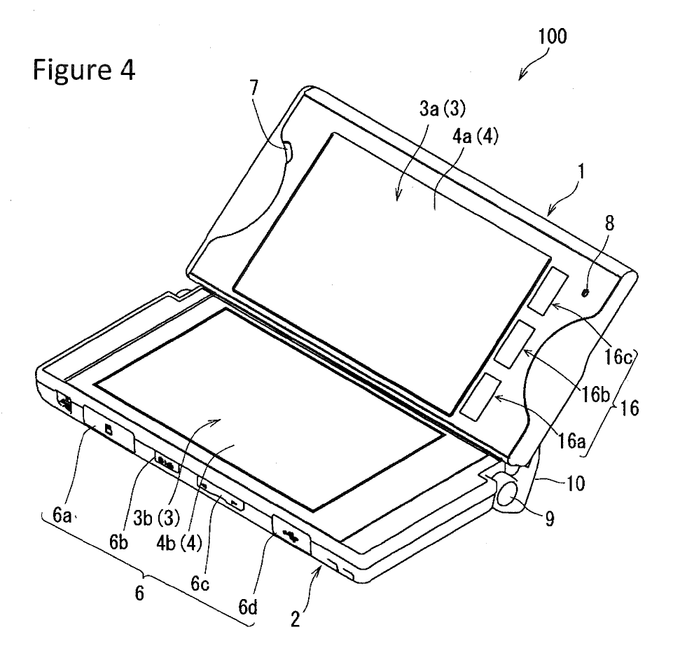

FIGS. 1 through 4 are perspective views showing the outer appearance of a mobile phone 100 according to Embodiment 1. The mobile phone 100 is, for example, an openable and closable mobile phone and comprises a first chassis 1 and a second chassis 2. FIG. 1 is a diagram showing the mobile phone 100 in the closed state when viewed from the first chassis 1. FIG. 2 is a diagram showing the mobile phone 100 in the closed state when viewed from the second chassis 2. FIGS. 3 and 4 show the mobile phone 100 in the open state.

The closed state of the mobile phone 100 is the state in which a first display screen 4a of a first display module 3a housed in the first chassis 1 is visible and the first chassis 1 and the second chassis 2 are layered over one another. In this case, because the first display screen 4a and a second display screen 4b of a second display module 3b housed in the second chassis 2 are layered over one another with space in between, the angle formed by the two may be 0°.

On the other hand, the open state of the mobile phone 100 is the state in which the first chassis 1 and the second chassis 2 are arranged so as not to be layered over one another, so that the first display screen 4a of the first display module 3a and the second display screen 4b of the second display module 3b are visible simultaneously. The mobile phone 100 is open in a manner in which the first display screen 4a and the second display screen 4b form an angle of 180° (i.e., are positioned on the same plane).

The mobile phone 100 is open in a manner in which the first display screen 4a and the second display screen 4b form an angle that is greater than 0° but less than 180°. In the following, the state in which the first display screen 4a and the second display 4b are positioned on the same plane is referred to as the “flat state”. Moreover, the open state in which the first display screen 4a and the second display 4b form an angle greater than 0° but less than 180° as shown in FIG. 4 is referred to as the “tilt state”.

The first display module 3a comprises a touch panel and functions as an operation module that accepts user operations on the first display screen 4a. Similarly, the second display module 3b comprises a touch panel and functions as an operation module that accepts user operations on the second display screen 4b. In the following, in cases in which it is not particularly necessary to distinguish the first display module 3a from the second display module 3b, they will both be referred to as the “display module 3”, and their respective display screens will be referred to as the “display screen 4”.

The first chassis 1 and the second chassis 2 are coupled via a hinge part 9 and an arm part 10. The hinge part 9 is provided on the second chassis 2. The arm part 10 is connected to the hinge part 9 in a manner allowing changes in angle relative to the second chassis 2. The arm part 10 is connected to the first chassis 1 in a manner allowing changes in angle relative to the first chassis 1. In the mobile phone 100, through movements of the hinge part 9 and the arm part 10, it is possible to shift from the closed state of FIGS. 1 and 2 to the tilt state of FIG. 4, and to shift from the tilt state of FIG. 4 to the flat state of FIG. 3.

In the mobile phone 100, through movements of the hinge part 9 and the arm part 10, it is possible to shift from the flat state of FIG. 3 to the tilt state of FIG. 4, and from the tilt state of FIG. 4 to the closed state of FIGS. 1 and 2. The means of coupling the first chassis 1 and the second chassis 2 is not limited to a coupling means composed of the hinge part 9 and the arm part 10, and the first chassis 1 and the second chassis 2 may be coupled using a coupling means of a different configuration.

In addition to the first display module 3a, the first chassis 1 comprises a sound output module 7, an audio input module 8, and a first operation module 16 that accepts user operations. The sound output module 7 comprises a speaker, and the audio input module 8 comprises a microphone.

The first operation module 16 comprises a Home button 16a, an Options button 16b, and a Back button 16c. These buttons are, for example, hardware keys, and are provided on the main surface on the side of the first display screen 4a. The home button 16a is an operation button for causing the mobile phone 100 to display a home screen (described later). The Options button 16b is an operation button for causing the mobile phone 100 to display a menu screen for executing option functions when an application program is being executed. The Back button 16c is an operation button for returning the display of the mobile phone 100a to the immediately previous display. The Home button 16a, the Options button 16b, and the Back button 16c each accept pressing operations by the user.

Furthermore, instead of hardware keys, the Home button 16a, the Options button 16b, and the Back button 16c may each be operation buttons displayed on the first display screen 4a by the first display module 3a that comprises a touch panel function.

In addition to the second display module 3b, the second chassis 2 is provided with a second operation module 6 that accepts user operations, and the lens of an imaging module 5 that captures images. The second operation module 6 comprises multiple operation buttons 6a-6d. The multiple operation buttons 6a-6d are each hardware keys and are provided on the side surface of the second chassis 2. The multiple operation keys 6a-6d each accept pressing operations by the user.

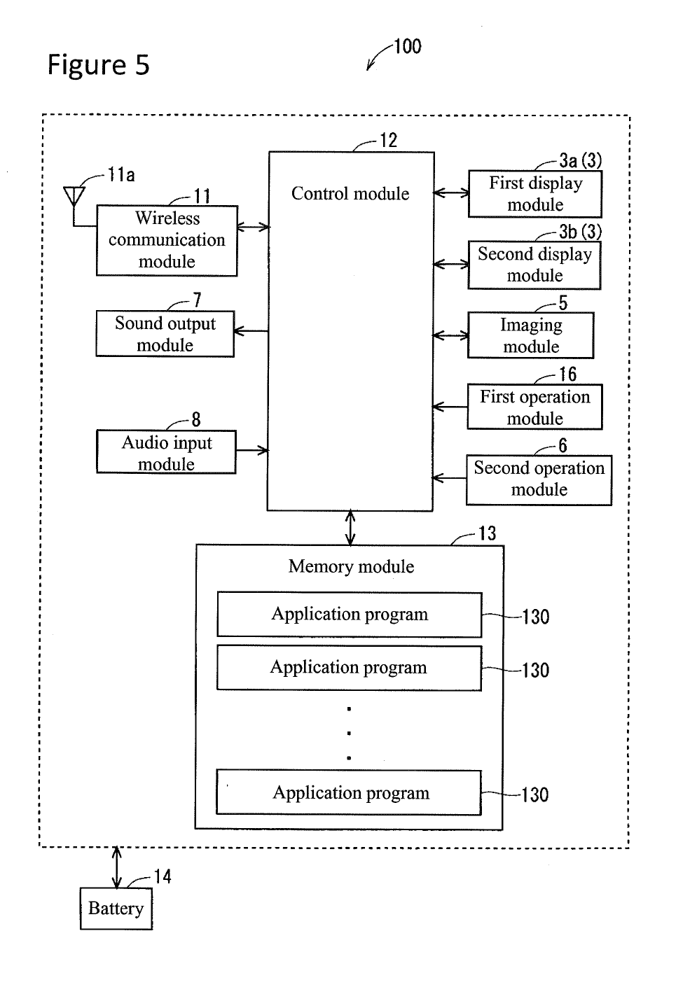

FIG. 5 is a functional block diagram of a mobile phone 100 (system 100) according to embodiment 1. In addition to the first display module 3a, the second display module 3b, the first operation module 16, the second operation module 6, the sound output module 7, the audio input module 8, and the imaging module 5, the mobile phone 100 also comprises a wireless communication module 11, a control module 12, a memory 13, and a battery 14.

The control module 12 is configured by a CPU (Central Processing Unit) and a DSP (Digital Signal Processor), etc., and manages operations of the mobile phone 100 by controlling the other components of the mobile phone 100. The control module 12 performs various operations in response to user operations accepted by the first display module 3a, the second display module 3b, the first operation module 16, and the second operation module 6.

The memory module 13 may be any suitable data storage area with suitable amount of memory that is formatted to support the operation of the system 100. Memory module 13 is configured to store, maintain, and provide data as needed to support the functionality of the system 100 in the manner described below. In practical embodiments, the memory module 13 may comprise, for example but without limitation, a non-volatile storage device (non-volatile semiconductor memory, hard disk device, optical disk device, and the like), a random access storage device (for example, SRAM, DRAM), or any other form of storage medium known in the art.

The memory module 13 may be coupled to the control module 12 and configured to store, for example but without limitation, an OS program and multiple application programs 130, or other application and data. The various functions of the control module 12 may be realized as a result of the CPU and DSP of the control module 12 executing the various programs in the memory 13.

The imaging module 5 is configured by a lens and an imaging element, etc., and captures still images and moving images under the control of the control module 12. Images captured by the imaging module 5 are stored in the memory 13. The control module 12 causes at least one of either the first display module 3a or the second display module 3b to display the images in the memory 13.

The wireless communication module 11 receives signals from mobile phones other than the mobile phone 100 or from communication devices such as servers connected to the Internet through a base station (not illustrated) using an antenna 11a. The wireless communication module 11 performs amplification processes and down conversion on the received signals and outputs them to the control module 12. The control module 12 performs a demodulation process, etc. on the input received signals and acquires various data such as audio data or image data contained in the received signals. Moreover, the wireless communication module 11 performs up conversion and an amplification process on transmission signals that are generated by the control module 12 and that contain audio data, etc., and transmits them wirelessly to mobile phones other than the mobile phone 100 or to communication devices connected to the Internet.

The sound output module 7 converts sound data such as audio data or music data from the control module 12 into sound and outputs it externally. The audio input module 8 converts audio input from an external source into audio data and outputs the data to the control module 12.

The first display module 3a and the second display module 3b comprise similar configurations. The display module 3 is, for example, a backlit liquid crystal display module that performs color display, and comprises a liquid crystal display panel and a backlight that radiates light thereto. The display module 3 displays various types of information such as characters, symbols, and diagrams on the display screen 4 under the control of the control module 12. The display module 3 may be a display module other than a liquid crystal display module. For example, the display module 3 may be an organic EL display, or a display module in which multiple LEDs are arranged in a matrix form.

The battery 14 generates power for the mobile phone 100. The power generated by the battery 14 is fed to each electronic module in the wireless communication module 11 and the control module 12, etc. contained in the mobile phone 100.

Various application programs (hereinafter referred to as “applications”) 130 are stored in the memory 13. For example, a call application for performing audio communication, a browser for displaying websites, an E-mail application for creating, browsing and sending and receiving E-mails, a camera application for capturing images using the imaging module 5, and a viewer application for displaying still images and moving images stored in the memory 13 are stored in the memory 13. Moreover, a music playback application for playing back music data stored in the memory 13, a market application for downloading applications from a server providing applications for a price or for free, a calculator application for executing a calculator function, a map application for downloading and displaying map data from a server providing map data, and an alarm application for executing an alarm function are stored in the memory 13. Moreover, a games application for playing puzzle games and other games on the mobile phone 100 is stored in the memory 13.

When the control module 12 reads out an application in the memory 13 and starts execution, the application is started up in the mobile phone 100. The control module 12 starts the execution of the application and functions as an application-program execution module that starts up the application. As a result of the control module 12 executing the application controlling the other components in the mobile phone 100, such as the wireless communication module 11, the display module 3, and the imaging module 5, the functions associated with the application (functions for performing audio communication, functions for displaying websites, functions for capturing images, etc.) are executed in the mobile phone 100.

<Icon Display>

In the mobile phone 100, under the control of the control module 12, the display module 3 is able to display icons for starting up the applications 130 stored in the memory 13. In the following, the terms “icons” or “startup icon” refer to icons for starting up the applications 130.

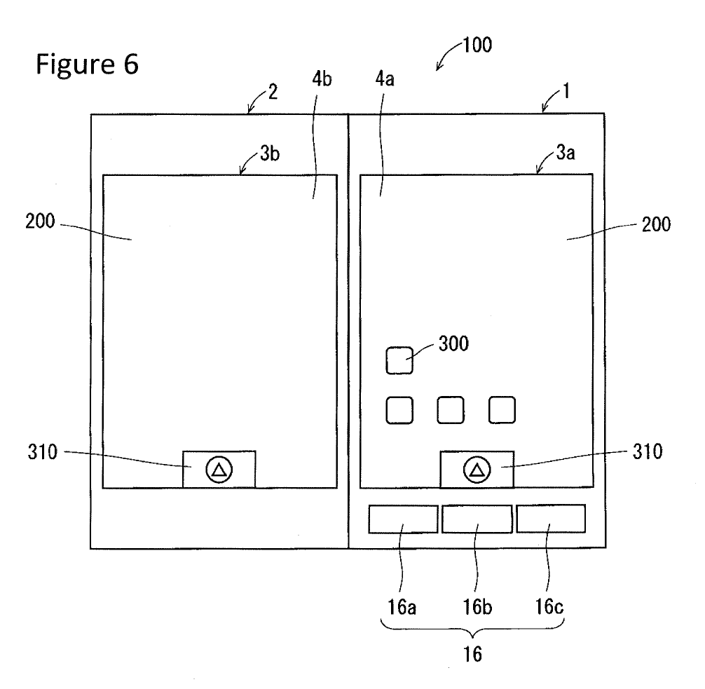

FIG. 6 is a diagram showing one example of a home screen (initial screen) 200 displayed by the mobile phone 100 in the open state (flat state or tilt state). In FIG. 6, compared to FIGS. 1-4, the structure of the mobile phone 100 has been simplified. The structure of the mobile phone 100 is simplified in subsequent diagrams as well. When the mobile phone 100 is in an open state in which the first display screen 4a and the second display 4b are arranged in the horizontal direction from the user's perspective, it may be referred to as “the mobile phone 100 in the horizontal open state”. On the other hand, when the mobile phone 100 is in an open state in which the first display screen 4a and the second display screen 4b are arranged in the vertical direction from the user's perspective, it may be referred to as “the mobile phone 100 in the vertical open state”. Unless otherwise stated, the terms “right side”, “left side”, “upper side”, and “lower side” respectively refer to the right side, left side, upper side, and lower side from the user's perspective when they view the mobile phone 100.

In the mobile phone 100 in the open state, when the Home button 16a of the first operation module 16 is operated, the home screen 200 is displayed across the first display screen 4a and the second display screen 4b. On the home screen 200, multiple icons 300 for starting up some of the applications 130 from among the multiple applications 130 stored in the memory 13 are shown. In the example of FIG. 6, four icons 300 are shown in the module displayed by the first display module 3a. The user is able to change the icons 300 shown on the home screen 200 by operating the first display screen 4a or the second display screen 4b. The user is able to, for example, display the icons 300 associated with the applications 130 with a high frequency of use by the user on the home screen 200.

Moreover, on the home screen 200, a Display button 310 for displaying an application list screen showing all of the applications 130 stored in the memory 13 is shown. Within the home screen 200, the Display button 310 is shown on both the module displayed by the first display module 3a and the module displayed by the second display module 3b. When the Display button 310 is operated, an application list screen is displayed on the display module 3 displaying the Display button 310.

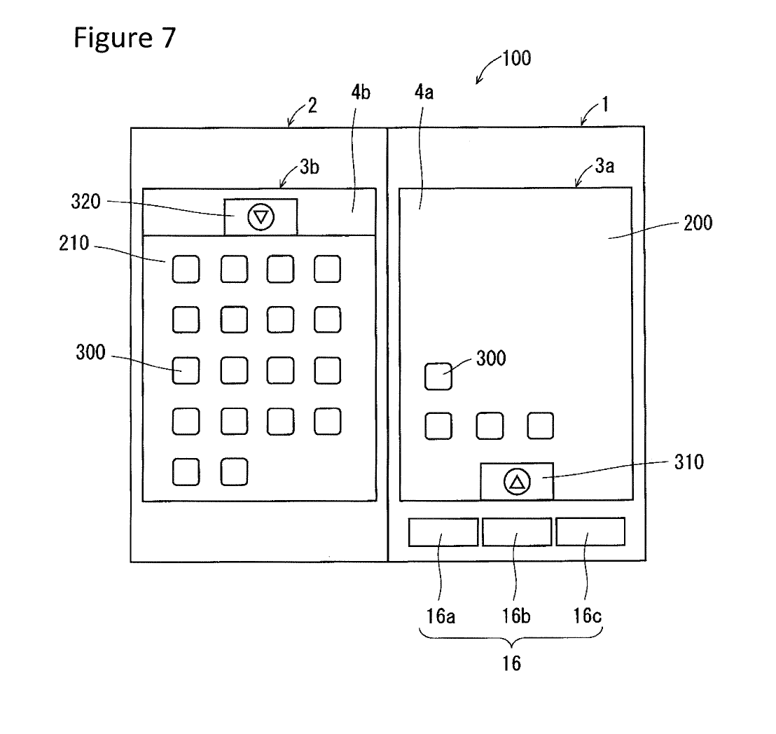

FIG. 7 is a diagram showing an example display of the mobile phone of Embodiment 1. Specifically, FIG. 7 is a diagram showing a state in which the application list screen 210 is displayed on the mobile phone 100. In the example of FIG. 7, in the mobile phone 100 shown in FIG. 6, the Display button 310 displayed by the second display module 3b is operated and the application list screen 210 is displayed on the second display module 3b.

On the application list screen 210, multiple icons 300 respectively associated with all of the applications 130 stored in the memory 13 are shown. In the example of FIG. 7, 18 of the icons 300 are shown on the application list screen 210. In FIG. 7 and FIG. 6, each of the multiple icons 300 is simplified and shown roughly as squares, but each icon 300 is actually displayed using various graphics. For example, for the graphic of the icon 300 associated with the call application, a graphic showing a receiver is used, and for the graphic of the icon 300 associated with the E-mail application, a graphic showing an envelope for a letter is used. Each icon 300 is simplified and shown roughly as a square in the following diagrams as well.

On the second display module 3b, together with the application list screen 210, a Hide button 320 for cancelling the display of the application list screen 210 is shown. When the Display button 310 displayed by the display module 3 is operated, the application list screen 210 and the Hide button 320 are displayed on the display module 3. When the Hide button 320 displayed by the display module 3 is operated, the application list screen 320 is erased from the display module 3, and returning to the state of FIG. 6, part of the Home screen 200 is displayed on the display module 3.

When either of the Display buttons 310 (refer to FIG. 6) displayed by the first display module 3a and the second display module 3b is operated, the application list screen 210 may be displayed across the first display screen 4a and the second display screen 4b. In this case, when either of the Hide buttons 320 displayed by the first display module 3a and the second display module 3b is operated, the application list screen 210 is erased from the first display screen 4a and the second display screen 4b, and the home screen 200 is displayed across the first display screen 4a and the second display screen 4b.

When the application list screen 210 is displayed across the first display screen 4a and the second display screen 4b, both the Display button 310 and the Hide button 320 may be displayed on one of either the first display screen 4a or the second display screen 4b.

When the user performs an operation issuing an instruction to start up the application 130 associated with the icon 300 (hereinafter referred to as a “startup instruction operation”) on an icon 300 shown on the home screen 200 or the application list screen 210, the control module 12 reads out the application 130 from the memory 13 and starts execution. As a result, the application 130 selected by the user is started up on the mobile phone 100. The startup instruction operation on the icon 300 may be, for example, a tap, which is an operation in which the display screen is touched with the finger and then quickly released.

In the mobile phone 100 in the closed state, the home screen 200 including the icons 300 and the Display button 310 is displayed on only the first display screen 4a that is visible to the user.

<Display Screens Used in the Execution of Each Application>

The multiple applications 130 stored in the memory 13 comprise applications 130 of type A, type B, and type C. The applications 130 of type A are applications 130 that start up only with a startup method in which only one display screen 4 is used for the execution of the application 130 (hereinafter referred to as the “one-screen startup method”). The applications 130 of type B are applications 130 for which startup is possible with multiple startup methods that each use a different display screen 4 for the execution of the application 130 from among the multiple simultaneously visible display screens 4. In the present example, the applications 130 of type B can be started up with the one-screen startup method as well as with a startup method in which two display screens 4 are used for the execution of the application 130 (hereinafter referred to as the “two-screen startup method”). The applications 130 of type C are applications 130 that start up only with the two-screen startup method.

The applications 130 of type A may be applications 130 in which the amount of information displayed during execution is not very high, and for which there are no problems with operability when used on only one display screen 4. For example, the call application, market application, calculator application, alarm application, and specific game applications (e.g., applications for puzzle games) are defined as the applications 130 of type A.

The applications 130 of type B may be applications 130 for which there are no problems related to the amount of information displayed or to operability when used on only one display screen 4 but are preferably used on two display screens 4 based on considerations of the amount of information displayed and the operability. For example, the browser, E-mail application, camera application, viewer application, music playback application, and map application are defined as the applications 130 of type B.

The applications 130 of type C may be applications designed to be used on two display screens 4. For example, specific game applications, such as applications for adversarial games, are defined as the applications 130 of type C.

The types of the applications 130 may be determined in advance, or may be set by the user by operating the display screens 4, etc. Moreover, the user may be able to change the predetermined types of the applications 130 by operating the display screens 4, etc.

In this way, for the applications 130 of type B, because startup is possible with multiple startup methods using different display screens 4 for the execution of the application 130 from among the multiple display screens 4, for the applications 130 of type B, the user may determine the display screen 4 used in the execution of the application 130 by arbitrarily selecting the startup method. When an application 130 of type B is starting up, the user is able to select the display screen 4 used in the execution of the application 130. Consequently, when the applications 130 of type B are started up, it is possible to prevent the user from using an undesirable display screen 4 due to the execution of the application 130.

<Method of Designating Startup Methods for Type B Applications>

Next, a method of designating startup methods for the applications 130 of type B will be described. Icons 300 associated with the applications 130 of type B are displayed on the application list screen 210 in multiple display modes respectively associated with multiple startup methods. For example, the icons 300 associated with the applications 130 of type B may be displayed in multiple display modes respectively associated with multiple startup methods by having the display modes of the icons 300 change over time.

In the present example, because the applications 130 of type B can be started up with the one-screen startup method and the two-screen startup method, the icons 300 associated with the applications 130 alternate between a display mode for one-screen startup that is associated with the one-screen startup method, and a display mode for two-screen startup that is associated with the two-screen startup method. In the following, the icons 300 associated with the applications 130 of type B may be referred to as “icons 300B for type B startup”.

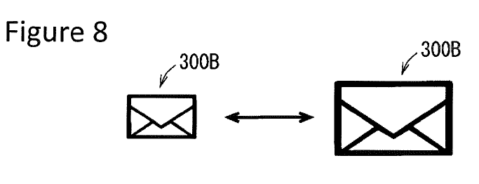

FIG. 8 is a diagram showing icons displayed by the mobile phone according to Embodiment 1. Specifically, FIG. 8 is a diagram showing an example of the display mode of the icon 300B for type B startup for starting up the E-mail application, which is type B application 130, alternating between the display mode for one-screen startup and the display mode for two-screen startup. In FIG. 8, the icons 300B for type B startup displayed in the display mode for one-screen startup are shown on the left side of the page, and the icons 300B for type B startup displayed in the display mode for two-screen startup are shown on the right side of the page.

The icons 300B for type B startup displayed in the display mode for two-screen startup are larger than the icons 300B for type B startup displayed in the display mode for one-screen startup. As a result of the display mode of the icons 300B for type B startup alternating between the display mode for one-screen startup and the display mode for two-screen startup, the size of the icons 300B for type B startup becomes large and becomes small.

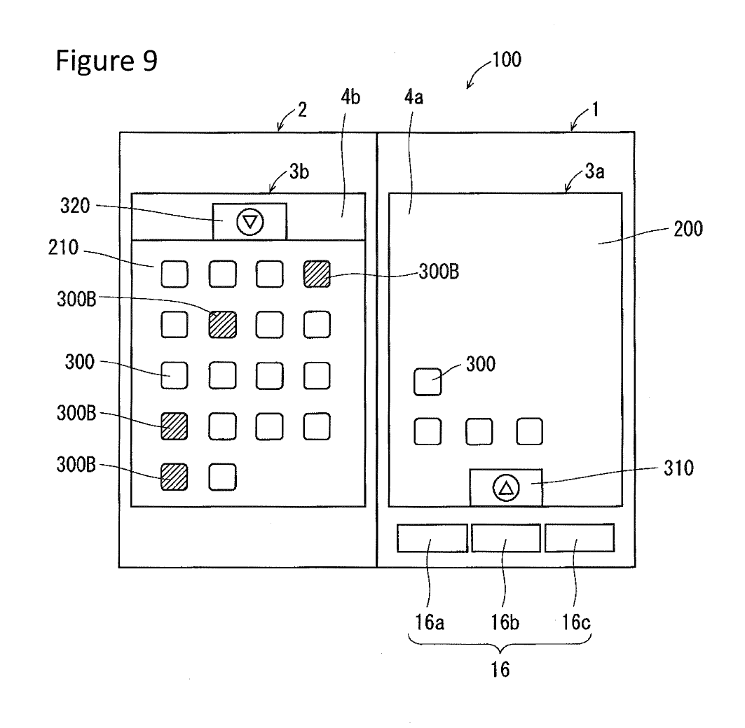

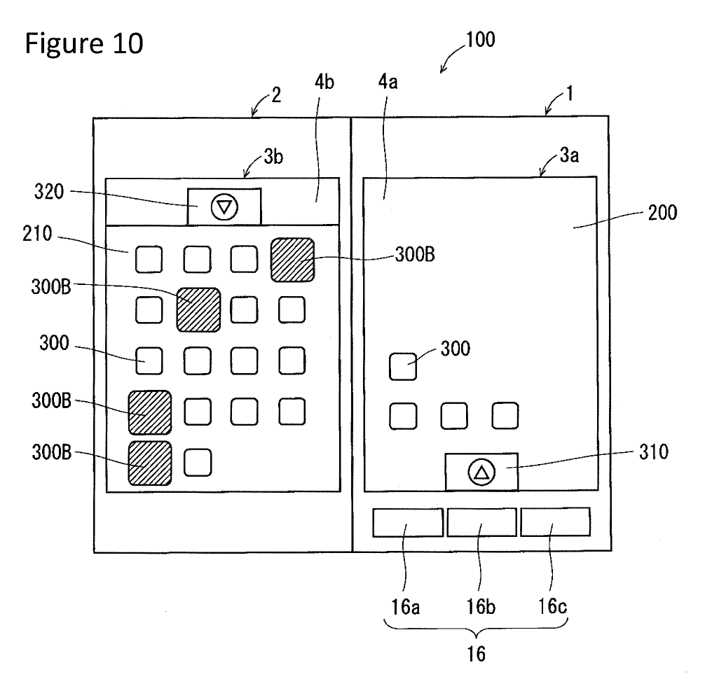

FIG. 9 and FIG. 10 are diagrams showing example displays of a mobile phone according to embodiment 1 of the disclosure. Specifically, FIG. 9 is a diagram showing an example of the icons 300B for type B startup being displayed in the display mode for one-screen startup in the application list screen 210, and FIG. 10 is a diagram showing an example of the icons 300B for type B startup being displayed in the display mode for two-screen startup in the application list screen 210.

In FIGS. 9 and 10, in order to distinguish the icons 300B for type B startup from the other icons 300, as a matter of convenience, diagonal lines are shown in the approximate squares indicating the icons 300B for type B startup. In subsequent diagrams as well, in order to distinguish the icons 300B for type B startup from the other icons 300, diagonal lines are shown in the approximate squares indicating the icons 300B for type B startup.

In the application list screen 210, the icons 300B for type B startup are displayed as animations, and those with a large size (the icons 300B for type B startup of FIG. 10) and those with a small size (the icons 300B for type B startup shown in FIG. 9) are displayed and alternated at a fixed interval. When the abovementioned display button 310 is displayed and the application list screen 210 is displayed on the display module 3, in the application list screen 210, the display modes of the icons 300B for type B startup automatically alternate between the display mode for one-screen startup (small size) and the display mode for two-screen startup (large size).

For the same icons 300B for type B startup, the icons 300B for type B startup displayed in the display mode for one-screen startup have similar shapes as the icons 300B for type B startup displayed in the display mode for two-screen startup.

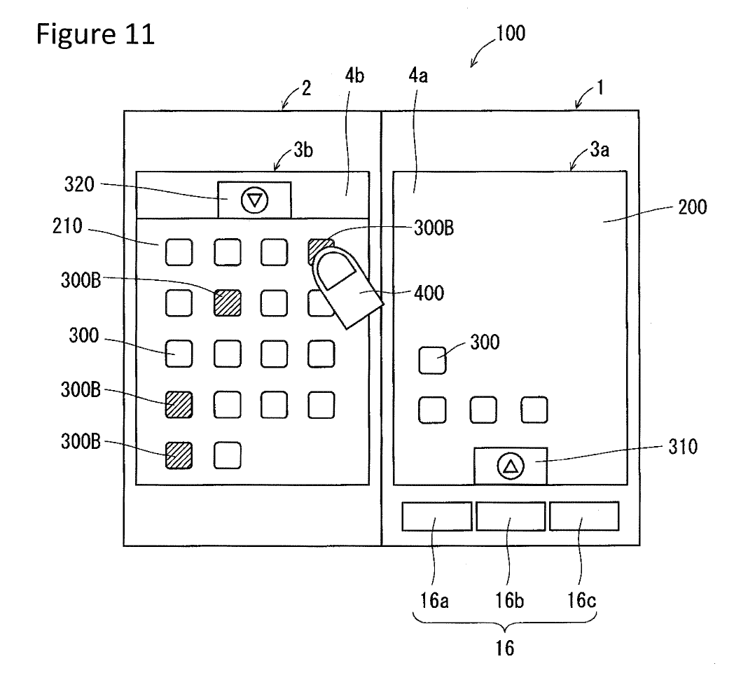

When the user uses their finger 400 (FIG. 11) and taps (performs a startup instruction operation) one of the icons 300B for type B startup displayed in the display mode for one-screen startup that is associated with the one-screen startup method, the control module 12 starts up the application 130 of type B associated with the icon 300B for type B startup with the one-screen startup method. Only one of the display screens 4 is used for the execution of the application 130 of type B. In the present embodiment, only the display screen 4 of the display module 3 displaying the icon 300B for type B startup that has been tapped is used. FIG. 11 is a diagram showing a startup instruction operation performed on the mobile phone according to Embodiment 1.

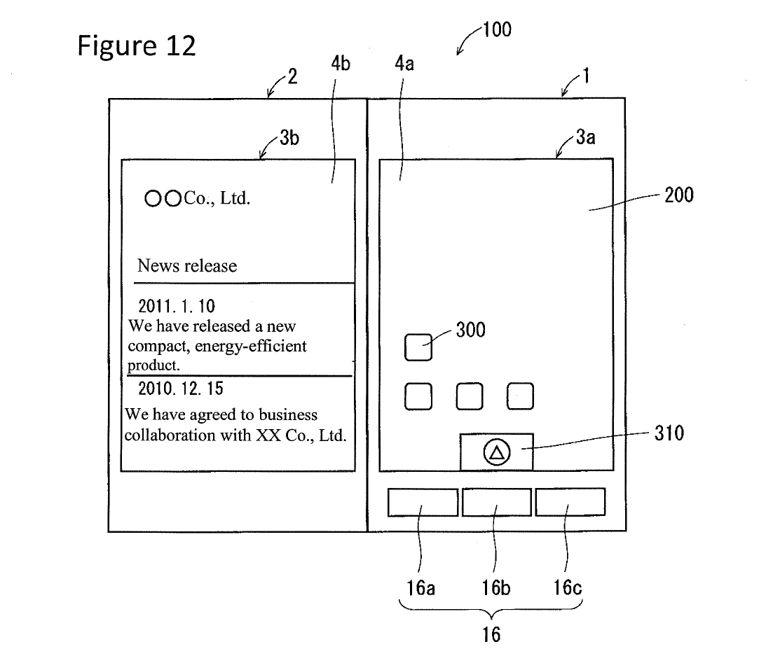

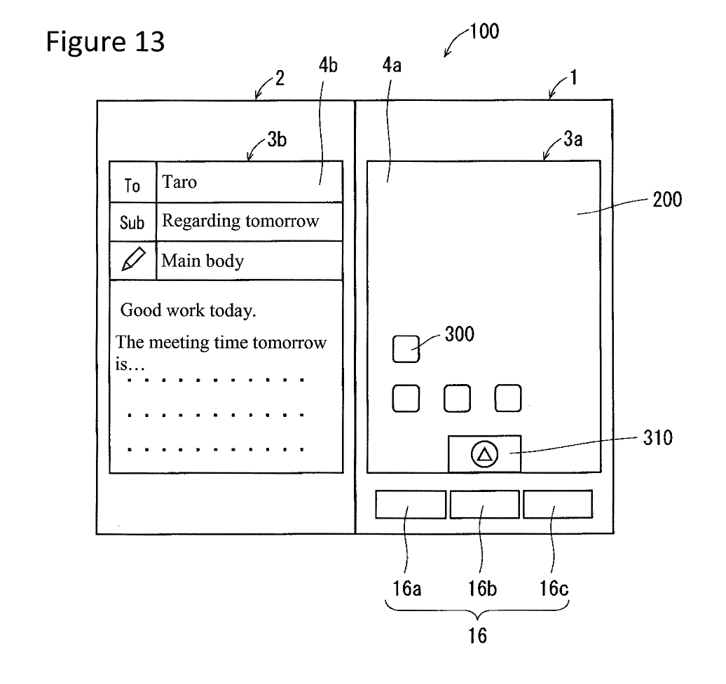

FIG. 12 is a diagram showing an example display of a mobile phone according to embodiment 1 of the disclosure. Specifically, FIG. 12 is a diagram showing an example display in which the browser has been started up with the one-screen startup method and is being executed in the mobile phone 100. FIG. 13 is a diagram showing an example display in which the E-mail application has been started up with the one-screen startup method and is being executed in the mobile phone 100.

When the browser is started up with the one-screen startup method, one website is displayed on the display screen 4 (the second display screen 4b in the example of FIG. 11). By operating the display screen 4 being used, the user is able to change the website being displayed on the display screen 4.

FIG. 13 is a diagram showing an example display of the mobile phone according to embodiment 1 of the disclosure. When the E-mail application is started up with the one-screen startup method, an outgoing E-mail creation screen is displayed on one of the display screens 4. By operating the display screen 4 being used, the user is able to transmit the outgoing E-mail that has been created or receive E-mails.

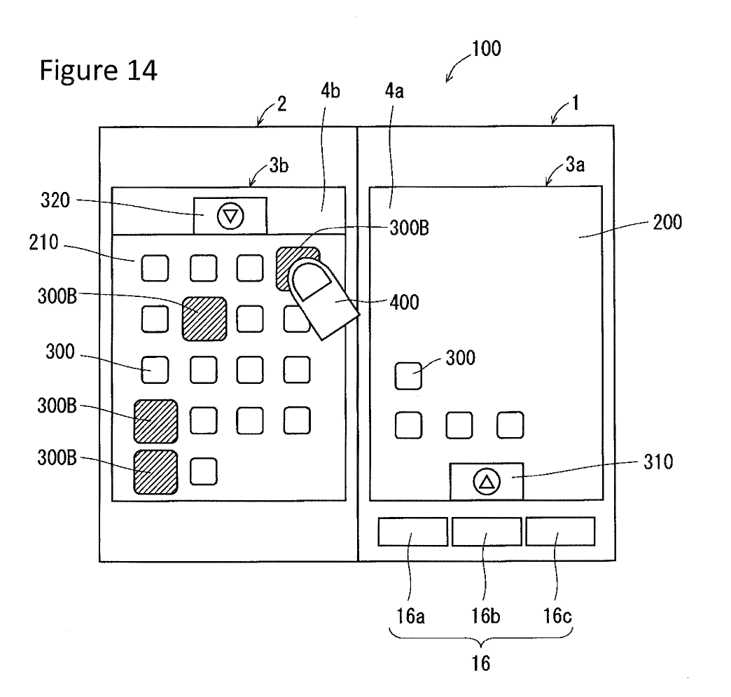

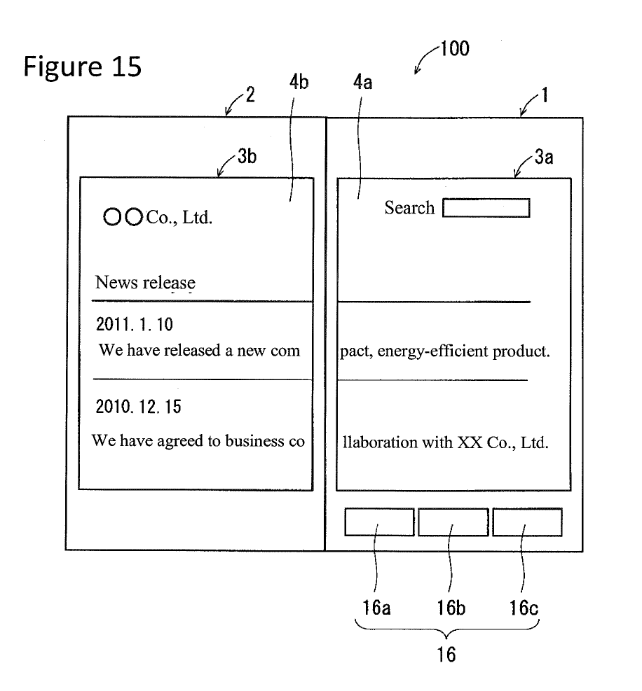

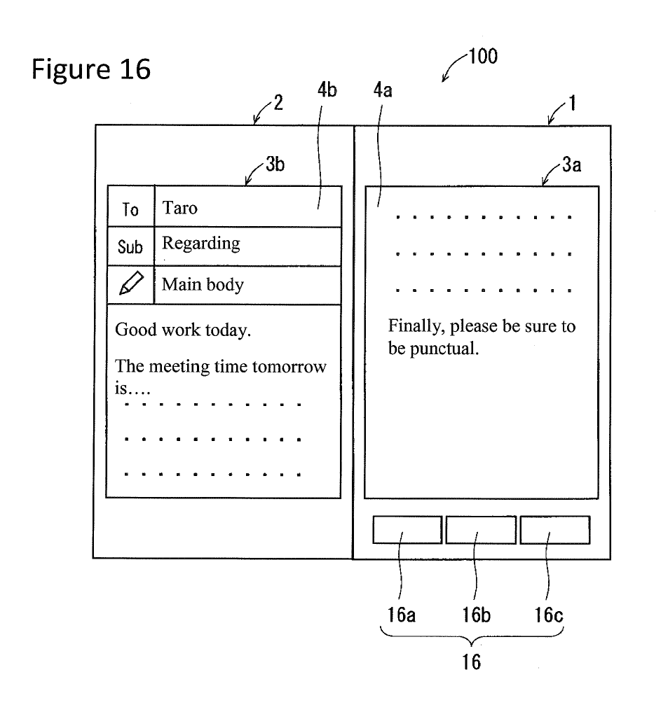

On the other hand, when the user uses their finger 400 and taps (activates) one of the icons 300B for type B startup displayed in the display mode for two-screen startup that is associated with the two-screen startup method, the control module 12 starts up the application 130 of type B associated with the icon 300B for type B startup with the two-screen startup method. As a result, two of the display screens 4 are used for the execution of the application 130 of type B. FIG. 14 is a diagram showing a startup instruction operation performed on the mobile phone according to embodiment 1 of the disclosure. FIG. 15 and FIG. 16 are diagrams showing example displays of the mobile phone according to embodiment 1 of the disclosure. Specifically, FIG. 15 is a diagram showing an example display in which the browser has been started up with the two-screen startup method and is being executed in the mobile phone 100, and FIG. 16 is a diagram showing an example display in which the E-mail application has been started up with the two-screen startup method and is being executed in the mobile phone 100.

When the browser is started up with the two-screen startup method, a website is displayed across the first display screen 4a and the second display screen 4b. By operating both of the two display screen 4, the user is able to change the website being displayed.

When the E-mail application is started up with the two-screen startup method, the outgoing E-mail creation screen is displayed across the first display screen 4a and the second display screen 4b. By operating both of the two display screens 4 being used, the user is able to transmit outgoing E-mails that have been created or receive E-mails.

When a startup instruction operation is performed on one of the icons 300 associated with one of the applications 130 of type A, for the execution of the application 130 of type A, the display screen 4 on which the startup instruction operation was performed is used. For example, let us say that the icon 300 associated with the alarm application, which is one of the applications 130 of type A, is displayed on the second display screen 4b. When a startup instruction operation is performed on the icon 300, the alarm application is started up with the one-screen startup method. During the execution of the alarm application, a settings screen for adjusting settings related to alarms (e.g., setting of alarm times, etc.) is displayed on the second display screen 4b.

When a startup instruction operation is performed on one of the icons 300 associated with one of the applications 130 of type C, during the execution of the application 130 of type C, both the first display screen 4a and the second display screen 4b are used. For example, when a startup instruction operation is performed on one of the icons 300 associated with a game application that is one of the applications 130 of type C, the game application is started with the two-screen startup method. Then, during the execution of the game application, screens related to the game are displayed across the first display screen 4a and the second display screen 4b.

Moreover, in the abovementioned FIG. 6, 7, 9, etc., the mobile phone 100 is shown in the horizontal open state, but even when the mobile phone 100 is in the vertical open state, the applications 130 of type B may be started up with multiple startup methods.

As described above, the icons 300B for type B startup that are for starting up the applications 130 of type B are displayed in multiple display modes respectively associated with multiple startup methods using different display screens 4 for the execution of the application 130 from among the multiple display screens 4. When a startup instruction operation is performed on one of the icons 300B for type B startup displayed in one of the multiple display modes, the application 130 associated with the icon 300B for type B startup is started up with the startup method associated with the display mode.

By performing startup instruction operations on the icons 300B for type B startup displayed with the display modes associated with the desired startup method, the user is able to start up the applications 130 associated with the icons 300B for type B startup with the desired startup method. Consequently, when operating one of the icons 300B for type B startup and starting up the associated application 130, the user is able to select the display screens 4 used for the execution of the application 130. When starting up the applications 130 of type B, it may be possible to prevent the use of any of the display screens 4 that the user does not wish to use.

### Variations of Embodiment 1

<First Variation>

In one embodiment, with regard to the applications 130 of type A or type B, there are cases in which the user wishes to change the display screens 4 used for the application 130 during the execution of the application 130. Consequently, after the application 130 of type A or type B has started up, the user may be able to change the display screens 4 used for the execution of the application 130 by, for example, operating the first operation module 16.

For example, when only one of the display screens 4 is being used for the execution of the browser, if the user operates the Options button 16b of the first operation module 16, a Change button for changing the display screen 4 used for the execution of the browser to both the first display screen 4a and the second display screen 4b is displayed on the first display screen 4a or the second display screen 4b. Then, when the user operates the Change button, the display screen 4 used for the execution of the browser becomes both the first display screen 4a and the second display screen 4b.

Moreover, when both the first display screen 4a and the second display screen 4b are used for the execution of the browser, if the user operates the Options button 16b of the first operation module 16, a first Change button and a second Change button for changing the display screen 4 used for the execution of the browser to only the first display screen 4a and only the second display screen, respectively, are displayed on the first display screen 4a or the second display screen 4b. Then, when the user operates the first Change button, the display screen 4 used for the execution of the browser becomes only the first display screen 4a. When the user operates the second Change button, the display screen 4 used for the execution of the browser becomes only the second display screen 4b as shown in FIG. 12.

<Second variation>

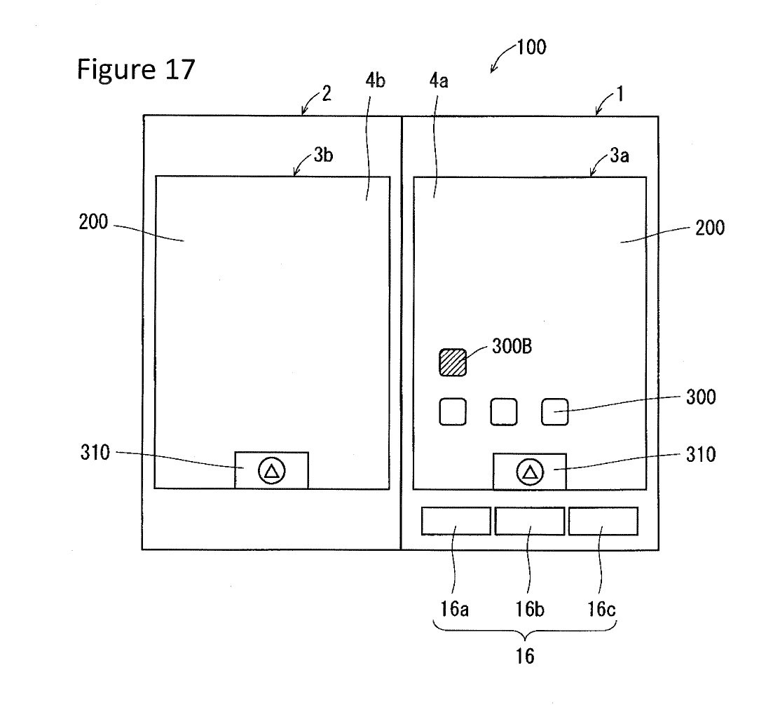

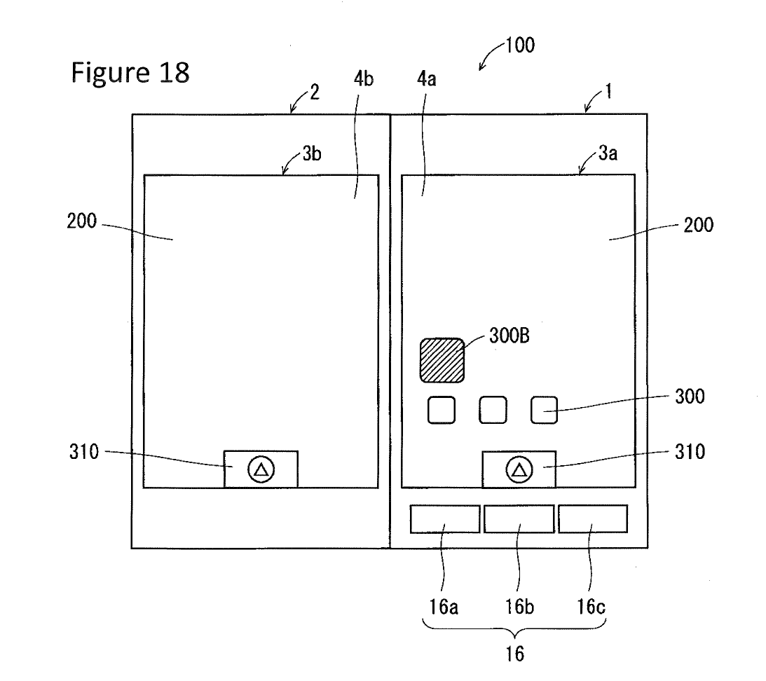

In one embodiment, the display modes of the icons 300B for type B startup shown on the application list screen 210 are changed according to startup method, but if the icons 300B for type B startup are being shown on the home screen 200, the display modes of the icons 300B for type B startup may be changed according to startup method. FIG. 17 and FIG. 18 are diagrams showing example displays of the mobile phone 100 according to an embodiment of the disclosure. FIG. 17 is a diagram showing the icons 300B for type B startup shown on the home screen 200 being displayed in the display mode for one-screen startup, and FIG. 18 is a diagram showing the icons 300B for type B startup shown on the home screen 200 being displayed in the display mode for two-screen startup.

When a startup instruction operation is performed on one of the icons 300B for type B startup, the application 130 associated with the icon 300B for type B startup is started up with the startup method corresponding to the display mode of the icon 300B for type B startup at that time. As a result, when the user operates the icon 300B for type B startup shown on the home screen 200 and starts up the associated application 130, they are able to select the startup method of the application 130.

<Third Variation>

In one embodiment, when starting up one of the applications 130 of type B with a startup method whereby only one of the display screens 4 is used for the execution of the application 130, the user may be able to select the display screen 4 used from among the first display screen 4a and the second display screen 4b.

The applications 130 of type B may be started up with a startup method whereby the display screen 4 used for the execution of the application 130 is the first display screen 4a only (hereinafter referred to as the “first one-screen startup method”), a startup method whereby the display screen 4 used for the execution of the application 130 is the second display screen 4b only (hereinafter referred to as the “second one-screen startup method”), and a startup method whereby two display screens 4 are used for the execution of the application 130 (two-screen startup method).

The display modes of the icons 300B for type B startup are set to sequentially and repeatedly change between a first display mode for one-screen startup associated with the first one-screen startup method, a second display mode for one-screen startup associated with the second one-screen startup method, and a display mode for two-screen startup associated with the two-screen startup method. For example, the icons 300B for type B startup displayed in the first display mode for one-screen startup are small icons, the icons 300B for type B startup displayed with the second display mode for one-screen startup are medium-sized icons, and the icons 300B for type B startup displayed with the display mode for two-screen startup are large icons.

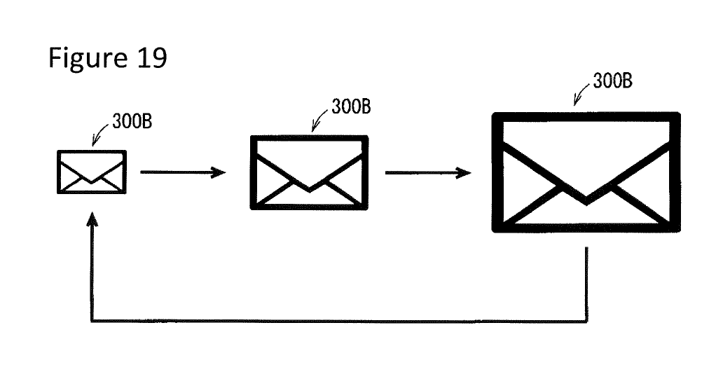

FIG. 19 is a diagram showing icons displayed on the mobile phone 100 according to an embodiment of the disclosure. Specifically, FIG. 19 is a diagram showing an example in which the display mode of the icon 300B for type B startup for starting up the E-mail application, which is one of the applications 130 of type B, sequentially and repeatedly changes between the first display mode for one-screen startup, the second display mode for one-screen startup, and the display mode for two-screen startup. In FIG. 19, the icons 300B for type B startup displayed in the first display mode for one-screen startup are shown on the left side, the icons 300B for type B startup displayed in the second display mode for one-screen startup are shown in the center, and the icons 300B for type B startup displayed in the display mode for two-screen startup are shown on the right side.

The display modes of the icons 300B for type B startup change sequentially in the order of the first display mode for one-screen startup, the second display mode for one-screen startup, and the display mode for two-screen startup, and returns to the first display mode for one-screen startup after the display mode for two-screen startup.

In the application list screen 210, when the user uses their finger 400 and taps (performs a startup instruction operation) one of the icons 300B for type B startup displayed in the first display mode for one-screen startup, the application 130 of type B associated with the icon 300B for type B startup is started up with the first one-screen startup method. For the execution of the application 130 of type B, only the first display screen 4a is used.

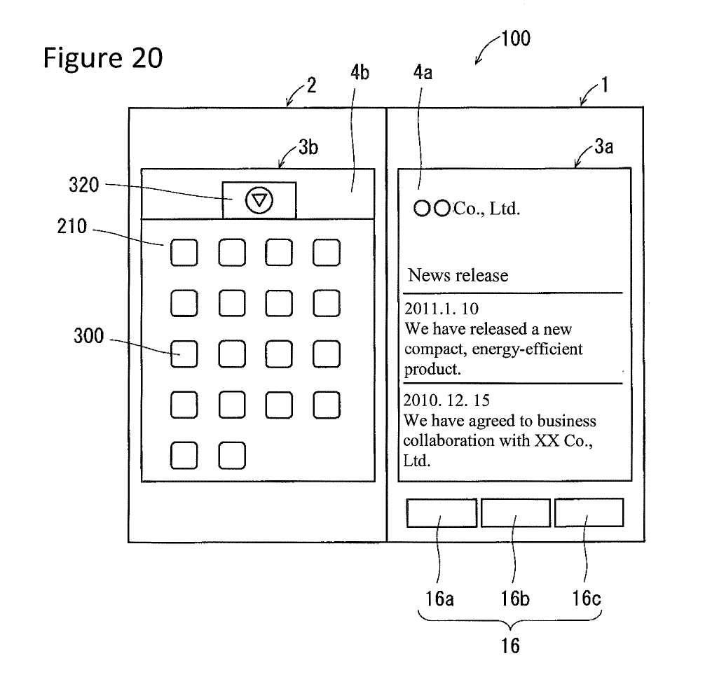

FIG. 20 is a diagram showing an example display of the mobile phone according to a variation of Embodiment 1. Specifically, FIG. 20 is a diagram showing an example display in which, when the application list screen 210 is being displayed on the second display screen 4b, the browser is started up with the first one-screen startup method and is being executed in the mobile phone 100. When the browser is started up with the first one-screen startup method, websites are displayed on only the first display screen 4a. On the second display screen 4b that is not being used for the execution of the browser, the application list screen 210 may be displayed, or part of the home screen 200 may be displayed.

Moreover, when the user uses their finger 400 and taps one of the icons 300B for type B startup displayed in the second display mode for one-screen startup on the application list screen 210, the application 130 of type B associated with the icon 300B for type B startup is started up with the second one-screen startup method. As a result, during the execution of the application 130 of type B, only the second display screen 4b is used. In this case as well, on the first display screen 4a that is not being used, the application list screen 210 may be displayed, or part of the home screen 200 may be displayed.

Then, when the user uses their finger 400 and taps one of the icons 300B for type B startup displayed in the display mode for two-screen startup on the application list screen 210, the application 130 of type B associated with the icon 300B for type B startup is started up with the two-screen startup method. During the execution of the application 130 of type B, both the first display screen 4a and the second display screen 4b are used.

Because it is possible to start up the applications 130 of type B with the first one-screen startup method, in which only the first display screen 4a is used, and the second one-screen startup method, in which only the second display screen 4b is used, the user is able to execute the applications 130 of type B using only a single desired display screen 4 from among the first display screen 4a and the second display screen 4b.

<Fourth Variation>

In one embodiment, as with the applications 130 of type B in the above third variation, the applications 130 of type A that are started up with only the one-screen startup method may be started up with the first one-screen startup method, in which only the first display screen 4a is used, and the second one-screen startup method, in which only the second display screen 4b is used. The applications 130 of type A may also be started up with multiple startup methods using different display screens 4 for the execution of the applications 130 from among the multiple display screens 4.

In this case, the display modes of the icons 300 for starting up the applications 130 of type A may alternate between a display mode associated with the first one-screen startup method and a display mode associated with the second one-screen startup method. When a startup instruction operation is performed on one of the icons 300 (e.g., a small icon 300) associated with one of the applications 130 of type A that is displayed in the display mode associated with the first one-screen startup method, the application 130 of type A is started up with the first one-screen startup method. Moreover, when a startup instruction operation is performed on one of the icons 300 (e.g., a large icon 300) associated with one of the applications 130 of type A that is displayed in the display mode associated with the second one-screen startup method, the application 130 of type A is started up with the second one-screen startup method.

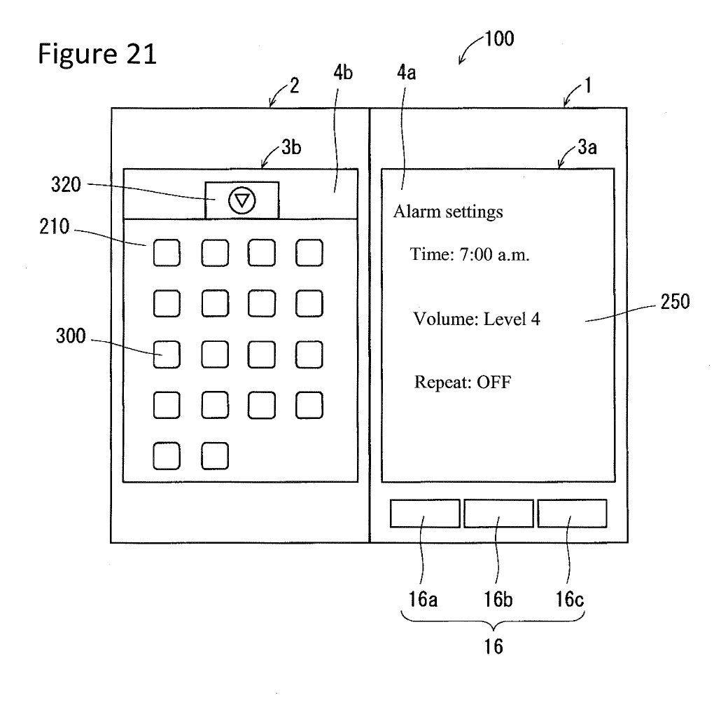

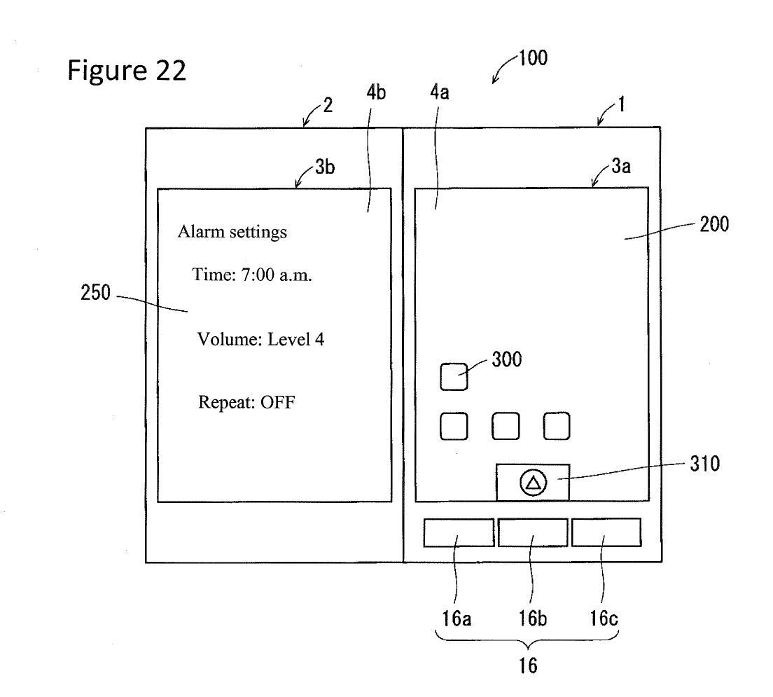

FIG. 21 is a diagram showing an example of a screen displayed during the execution of an alarm application when the alarm application, which is a type A application, has been started up with the first one-screen startup method. FIG. 22 is a diagram showing an example of a screen displayed during the execution of the alarm application when the alarm application has been started up with the second one-screen startup method.

When the alarm application is started up with the first one-screen startup method, an alarm settings screen 250 for adjusting settings related to alarms is displayed on the first display screen 4a. When the alarm application is started up with the second one-screen startup method, the alarm settings screen 250 is displayed on the second display screen 4b. On the display screen 4 that is not used for the execution of the alarm application, the application list screen 210 may be displayed, or part of the home screen 200 may be displayed.

<Fifth Variation>

In an embodiment when changing the display modes of the icons 300B for type B startup in association with the startup methods, the sizes of the icons 300B for type B startup have been changed, but the display modes of the icons 300B for type B startup may be changed through another method.

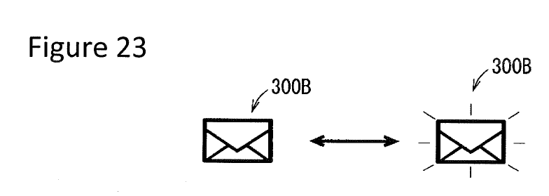

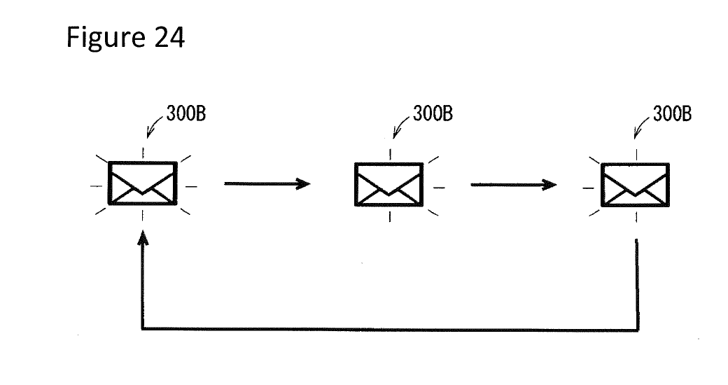

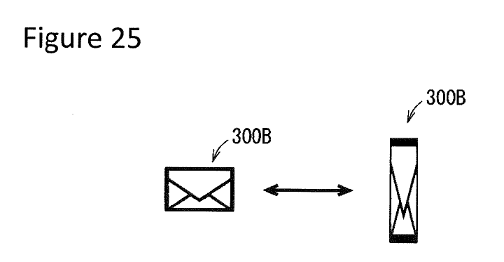

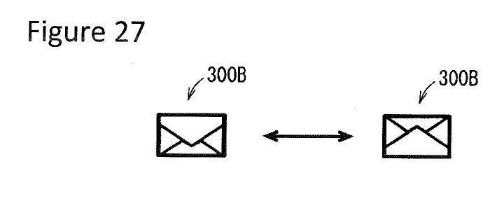

For example, the colors of the icons 300B for type B startup may be changed in association with the startup methods. FIG. 23 is a diagram showing icons displayed by the mobile phone according to a variation of Embodiment 1. Specifically, FIG. 23 is a diagram showing the color of the icon 300B for type B startup for starting up the E-mail application changing. FIG. 24 is a diagram showing the color of the icon 300B for type B startup for starting up the E-mail application changing in the abovementioned third variation of Embodiment 1. In FIG. 23 as well as FIGS. 25 and 27 (described below), the icons 300B for type B startup displayed in the display mode for one-screen startup associated with the one-screen startup method are shown on the left side, and the icons 300B for type B startup displayed in the display mode for two-screen startup associated with the two-screen startup method are shown on the right side.

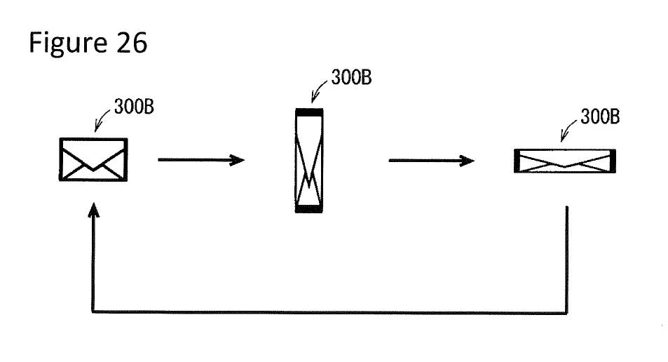

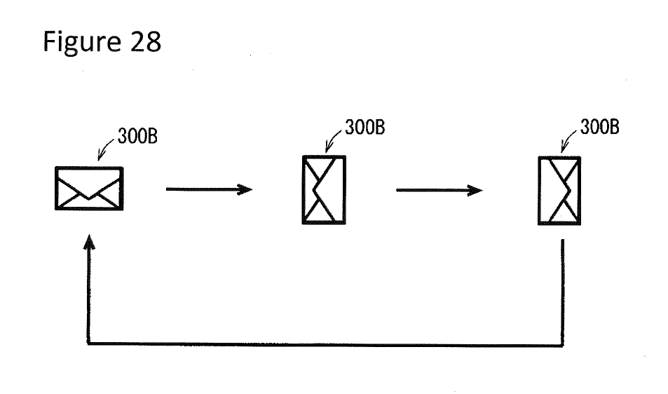

In FIG. 24 as well as FIGS. 26 and 28 (described below), the icons 300B for type B startup displayed in the display mode for two-screen startup associated with the two-screen startup method are shown on the left side, the icons 300B for type B startup displayed in the first display mode for one-screen startup associated with the first one-screen startup method are shown in the center, and the icons 300B for type B startup displayed in the second display mode for one-screen startup associated with the second one-screen startup method are shown on the right side.

By making the colors of the icons 300B for type B startup displayed in the display mode for one-screen startup and the display mode for two-screen startup different, the icons 300B for type B startup displayed in the display mode for two-screen startup may be made to look bright as a whole, and the icons 300B for type B startup displayed in the display mode for one-screen startup may be made to not look bright.

Moreover, by making the colors of the icons 300B for type B startup displayed in the first display mode for one-screen startup, the second display mode for one-screen startup, and the display mode for two-screen startup different, the icons 300B for type B startup displayed in the display mode for two-screen startup (left side) may be made to look bright as a whole, the icons 300B for type B startup displayed in the first display mode for one-screen startup (center) may be made to look bright on the right half, and the icons 300B for type B startup displayed in the second display mode for one-screen startup may be made to look bright on the left half.

In this case, for both the first and second display modes for one-screen startup of the icons 300B for type B startup, the positions of the parts that appear bright in the display modes are associated with the positions of the display screens 4 used for the execution of the applications 130 started up with the startup methods associated with the display modes. For example, for the icons 300B for type B startup displayed in the first display mode for one-screen startup, the “right side” is made bright, and the first display screen 4a that is on the “right side” is used for the execution of the application 130 started up with the first one-screen startup method associated with the first display mode for one-screen startup. Consequently, when starting up the application 130, it becomes easy for the user to intuitively select the display screen 4 used for the execution of the application 130.

Moreover, the outlines of the icons 300B for type B startup may be changed using dissimilar shapes associated with the startup methods. FIG. 25 is a diagram showing the outline of the icon 300B for type B startup for starting up the E-mail application changing between dissimilar shapes in the abovementioned Embodiment 1. FIG. 26 is a diagram showing the outline of the icon 300B for type B startup for starting up the E-mail application changing between dissimilar shapes in the abovementioned third variation.

The outline of the icons 300B for type B startup displayed in the display mode for two-screen startup is a shape that is vertically longer than the outline of the icons 300B for type B startup displayed in the display mode for one-screen startup. The outline of the icons 300B for type B startup displayed in the first display mode for one-screen startup (center of the page) is a shape that is vertically longer than the outline of the icons 300B for type B startup displayed in the display mode for two-screen startup (left side of page), and the outline of the icons 300B for type B startup displayed in the second display mode for one-screen startup (right side of page) is a shape that is horizontally longer than the outline of the icons 300B for type B startup displayed in the display mode for two-screen startup.

The icons 300B for type B startup may be rotated in association with the startup methods. FIG. 27 and FIG. 28 are diagrams showing the icon 300B for type B startup for starting up the E-mail application rotating.

The icons 300B for type B startup displayed in the display mode for two-screen startup are the icons 300B for type B startup displayed in the display mode for one-screen startup rotated by 180°. The icons 300B for type B startup displayed in the first display mode for one-screen startup (center) are the icons 300B for type B startup displayed in the display mode for two-screen startup (left side) rotated by 90° to the right (clockwise direction) from the user's perspective. The icons 300B for type B startup displayed in the second display mode for one-screen startup (right side) are the icons 300B for type B startup displayed in the display mode for two-screen startup rotated by 90° to the left (counterclockwise direction) from the user's perspective.

In this case, for both the first and second display modes for one-screen startup of the icons 300B for type B startup, the directions of rotation of the icons 300B for type B startup displayed in the display modes are associated with the positions of the display screens 4 used for the execution of the applications 130 executed with the startup methods associated with the display modes. For example, the icons 300B for type B startup displayed in the first display mode for one-screen startup are rotated to the “right”, and the first display screen 4a on the “right” side is used for the execution of the application 130 started up with the first one-screen startup method associated with the first display mode for one-screen startup. Consequently, when starting up the application 130, it is easy for the user to intuitively select the display screen 4 used for the execution of the application 130.

<Sixth Variation>

In an embodiment, a configuration may be provided in which the display mode of the icons 300B for type B startup changes only after the user selects one of the icons 300B for type B startup. The following is a detailed description of the present variation.

When the application list screen 210 is displayed on the mobile phone 100, the icons 300B for type B startup are first displayed in the same display mode as the display mode for one-screen startup. Then, when the user performs a selection operation on one of the icons 300B for type B startup, the display mode of the icon 300B for type B startup alternates between the display mode for one-screen startup and the display mode for two-screen startup. The selection operation performed on the icon 300B for type B startup may be, for example, an operation in which the icon 300B for type B startup is touched with a finger. In other words, when the user touches the icon 300B for type B startup with their finger, an animated display of the icon 300B for type B startup is started and the display modes changes.

After the user performs a selection operation on the icon 300B for type B startup, when a startup instruction operation is performed on the icon 300B for type B startup, the application 130 associated with the icon 300B for type B startup is started up with the startup method corresponding to the display mode of the icon 300B for type B startup at the time when the startup instruction operation was performed. The startup instruction operation performed on the icon 300B for type B startup may be an operation in which, for example, the finger touching the icon 300B for type B startup when selecting the icon 300B for type B startup is released from the icon 300B for type B startup.

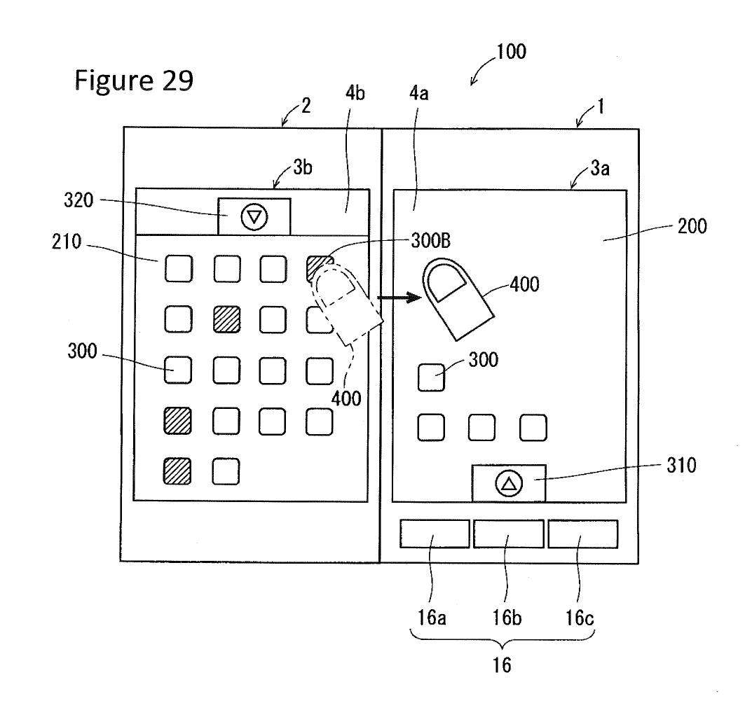

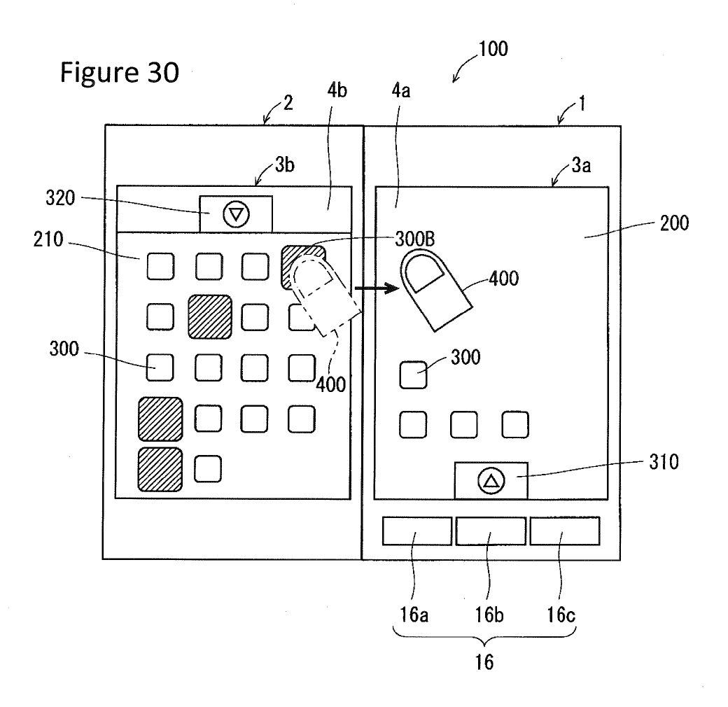

During the period when the user is touching the icon 300B for type B startup with their finger, the display mode of the icon 300B for type B startup changes. When the user releases their finger from the icon 300B for type B startup, the application 130 associated with the icon 300B for type B startup is started up with the startup method corresponding to the display mode of the icon 300B for type B startup at that time. FIG. 29 and FIG. 30 are diagrams showing startup instruction operations performed on the mobile according to an embodiment. When the user releases his/her finger 400 touching the icon 300B for type B startup displayed in the display mode for one-screen startup from the icon 300B for type B startup, the application 130 associated with the icon 300B for type B startup is started up with the one-screen startup method. On the other hand, when the user releases his/her finger 400 touching the icon 300B for type B startup displayed in the display mode for two-screen startup from the icon 300B for type B startup, the application 130 associated with the icon 300B for type B startup is started up with the two-screen startup method.

In the third variation as well, the display mode of the icons 300B for type B startup may change only after the user selects one of the icons 300B for type B startup. In the fourth variation as well, the display mode of the icons 300 may change only after the user selects one of the icons 300 for starting up one of the applications 130 of type A.

<Seventh Variation>

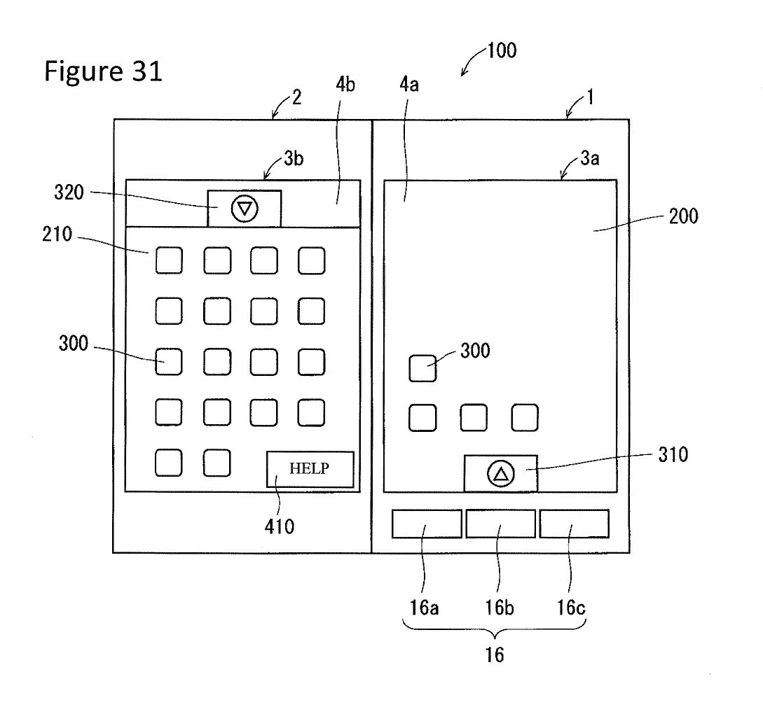

Regarding the applications 130 of type B, because they can be started up with multiple startup methods, a help screen showing methods of starting up using each startup method may be displayed. FIG. 31 is a diagram showing an example display of the mobile phone according to a variation of Embodiment 1. FIG. 31 is a diagram showing the application list screen 210 according to the present variation. On the application list screen 210 according to the present variation, the Display button 410 for displaying the help screen is shown.

When the user operates the Display button 410, a help screen 420 is displayed over the application list screen 210. The help screen 420 shows methods of starting up the applications 130 of type B with the one-screen startup method and the two-screen startup method. The help screen 420 also shows a button 420a for closing the screen. When the button 420a is operated, the help screen 420 is no longer displayed.

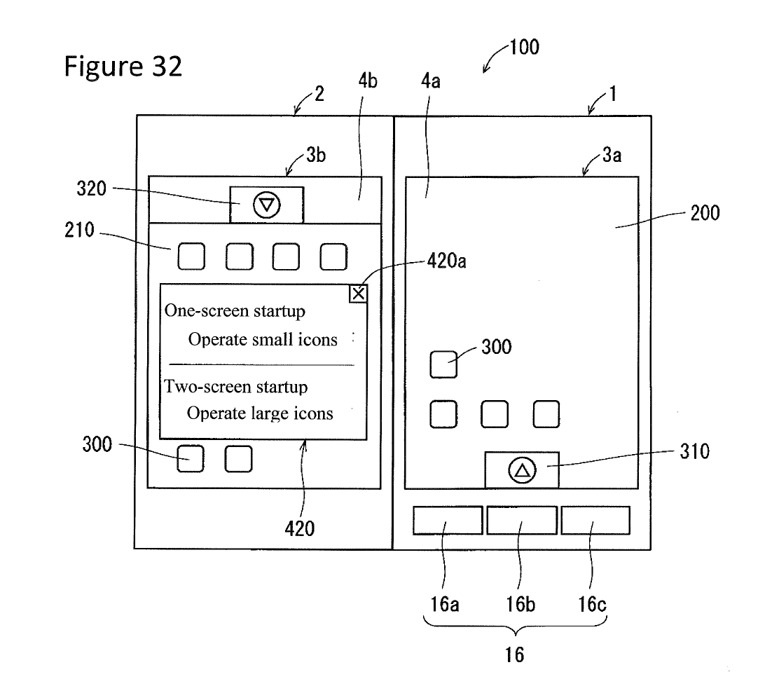

By displaying the help screen 420 shown FIG. 32, the user is able to confirm methods of starting up using each of the startup methods of the applications 130 of type B on the display screen 4.

Furthermore, if the applications 130 of type A can be started up with multiple startup methods as in the above fourth variation, methods of starting up using each of the multiple startup methods may be displayed on the help screen 420.

<Eighth Variation>

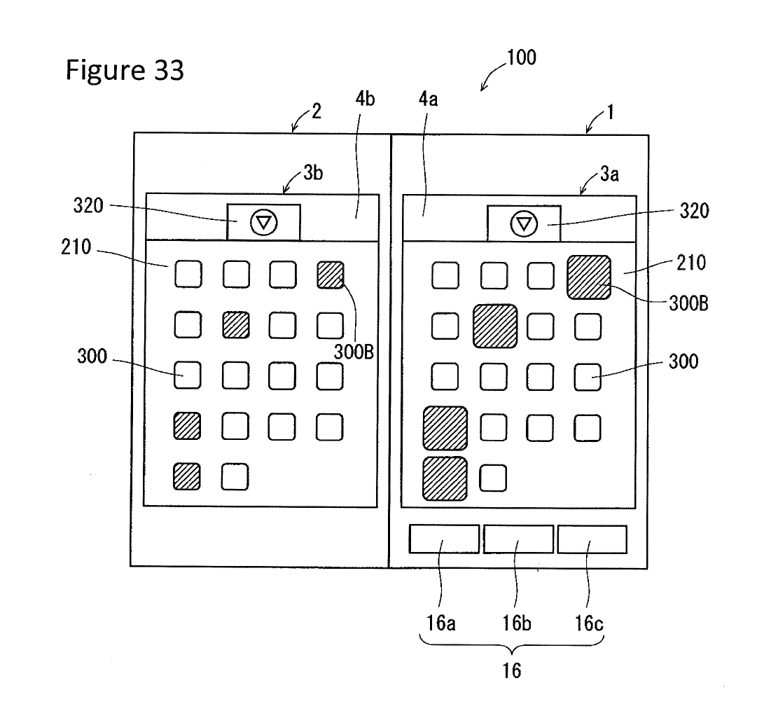

The icons 300B for type B startup may be displayed simultaneously in multiple display modes. FIG. 33 is a diagram showing the icons 300B for type B startup displayed simultaneously in multiple display modes in the application list screen 210 displayed across the first display screen 4a and the second display screen 4b.

In the example of FIG. 33, the icons 300B for type B startup are displayed in the display mode for one-screen startup in the second display screen 4b, and displayed in the display mode for two-screen startup in the first display screen 4a. Regarding each of the icons 300B for type B startup, the display positions of the icons 300B for type B startup displayed in the display mode for one-screen startup in the second display screen 4b match the display positions of the icons 300B for type B startup displayed in the display mode for two-screen startup in the first display screen 4a.

When the user performs a startup instruction operation on one of the icons 300B for type B startup displayed in the display mode for one-screen startup on the second display screen 4b, the application 130 associated with the icon 300B for type B startup is started up with the one-screen startup method. On the other hand, when the user performs a startup instruction operation on one of the icons 300B for type B startup displayed in the display mode for two-screen startup on the first display screen 4a, the application 130 associated with the icon 300B for type B startup is started up with the two-screen startup method.

The icons 300B for type B startup may be displayed in the display mode for one-screen startup in the first display screen 4a and in the display mode for two-screen startup in the second display screen 4b.

In the example of FIG. 33, the icons 300B for type startup are displayed simultaneously in multiple display modes using both the first display screen 4a and the second display screen 4b, but the application list screen 210 may be displayed on only one of either the first display screen 4a or the second display screen 4b to simultaneously display the icons 300B for type B startup in multiple display modes in only that one screen.

### Embodiment 2

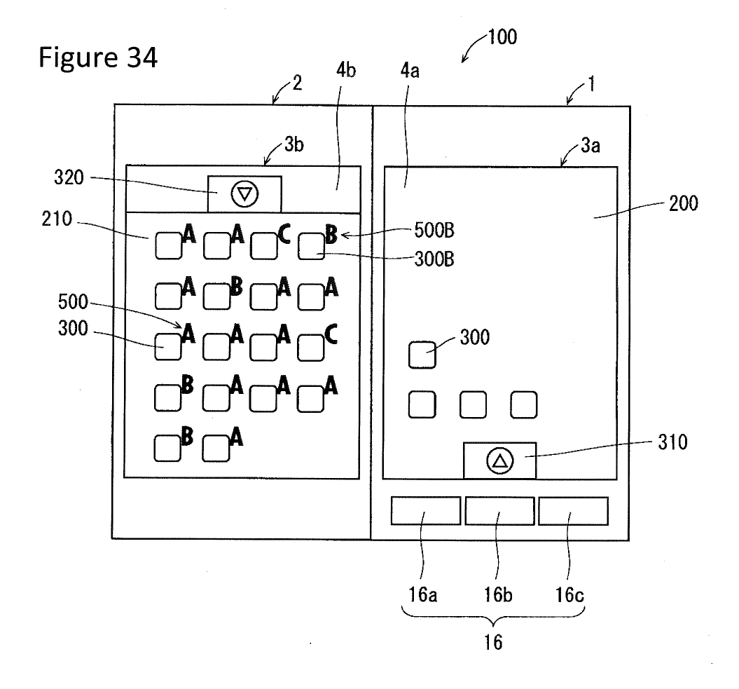

FIG. 34 is an example display of the mobile phone according to Embodiment 2. Specifically, FIG. 34 is a diagram showing an example display of the application list screen 210 in the mobile phone 100 according to an embodiment. In the application list screen 210, along with the icons 300, identification information 500 for identifying the respective types of the applications 130 associated with the icons 300 is displayed. In the following, the mobile phone 100 according to the present embodiment will be described by focusing on differences with the mobile phone 100 according to Embodiment 1.

In the application list screen 210, near each of the icons 300, the identification information 500 identifying the respective types of the applications 130 associated with the icons 300 is shown. In the present embodiment, alphabetic characters indicating the types of the applications 130 are used as the identification information 500 for identifying the respective types of the applications 130. The identification information 500 may be shown using non-alphabetic characters, or may be shown using symbols or graphics.

The display mode of the identification information 500 displayed together with the icons 300B for type B startup (hereinafter referred to as “type B identification information 500B”) changes over time between multiple display modes associated with each of the multiple startup methods (one-screen startup method and two-screen startup method) of the applications 130 associated with the icons 300B for type B startup. Then, when a startup instruction operation is performed on one of the icons 300B for type B startup, the application 130 associated with the icon 300B for type B startup is started up with the startup method corresponding to the current display mode of the type B identification information 500B associated with the icon 300B for type B startup.

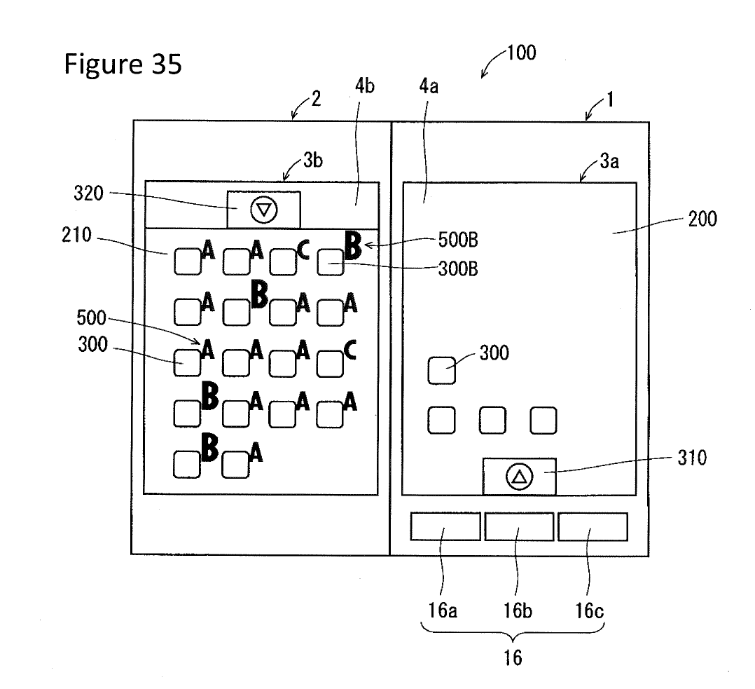

The type B identification information 500B displayed in the display mode associated with the two-screen startup method is displayed larger than the identification information 500 displayed in the display mode associated with the two-screen startup method. In FIG. 34, the type B identification information 500B displayed in the display mode associated with the one-screen startup method is shown. FIG. 35 shows the type B identification information 500B displayed in the display mode associated with the two-screen startup method.

In the mobile phone 100, when the application list screen 210 is displayed, each item of type B identification information 500B is automatically displayed as an animation, and small-sized items (associated with the one-screen startup method) and large-sized items (associated with the two-screen startup method) are alternately displayed at a fixed interval.

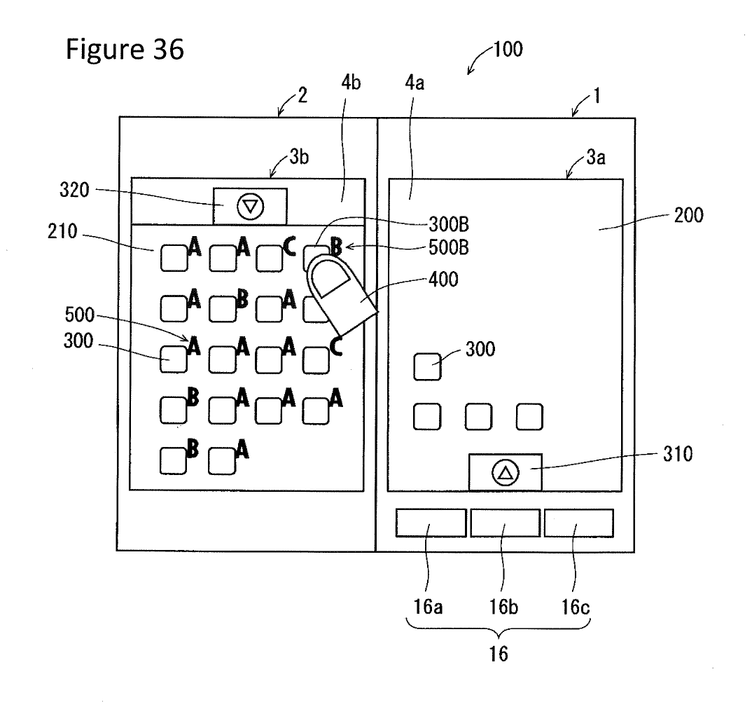

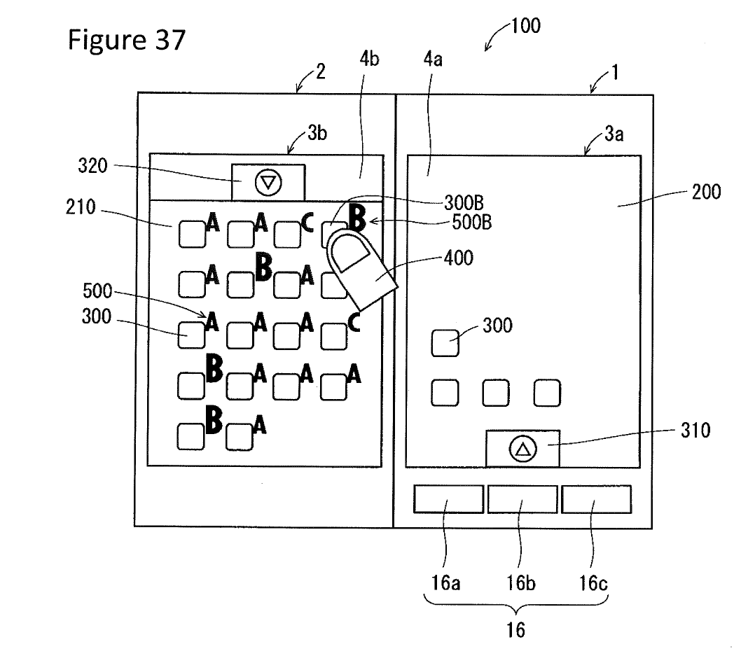

FIG. 36 and FIG. 37 are diagrams showing startup instruction operations performed on the mobile phone according to Embodiment 2. When the type B identification information 500B is displayed in the display mode associated with the one-screen startup method, if the user's finger 400 taps (performs a startup instruction operation) on one of the icons 300B for type B startup associated with the type B identification information 500B, the application 130 associated with the icon 300B for type B startup is started up with the one-screen startup method. On the other hand, when the type B identification information 500B is displayed in the display mode associated with the two-screen startup method, if the user's finger 400 taps one of the icons 300B for type B startup associated with the type B identification information 500B, the application 130 associated with the icon 300B for type B startup is started up with the two-screen startup method.

As described above, in the present embodiment, the type B identification information 500B is displayed in multiple display modes associated with the multiple startup methods of the applications 130 related to the associated icons 300B for type B startup. Then, when a startup instruction operation is performed on one of the icons 300B for type B startup, the application 130 associated with the icon 300B for type B startup is started up with the startup method associated with the display mode at the time of the type B identification information 500B associated with the icon 300B for type B startup.

By performing a startup instruction operation on the icon 300B for type B startup associated with the type B identification information 500B displayed in the display mode associated with the desired startup method, the user is able to startup the application 130 associated with the icon 300B for type B startup with the desired startup method. By performing an operation on the icon 300B for type B startup, when starting up the associated application 130, the user is able to select the display screen 4 used for the execution of the application 130. As a result, it is possible to prevent the use of the display screen 4 that the user does not wish to use when the application 130 of type B is started up.

### Variations of Embodiment 2

Various variations of Embodiment 2 will be described below.

<First Variation>

Regarding the applications 130 of type A or type B, after the startup of the application 130, the user may change the display screen 4 used for the execution of the application 130 by, for example, operating the first operation module 16.

<Second Variation>

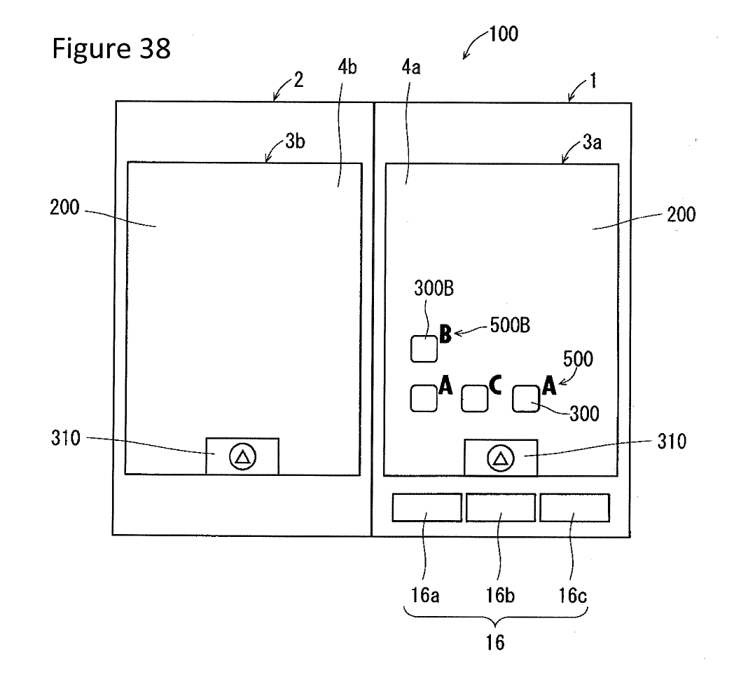

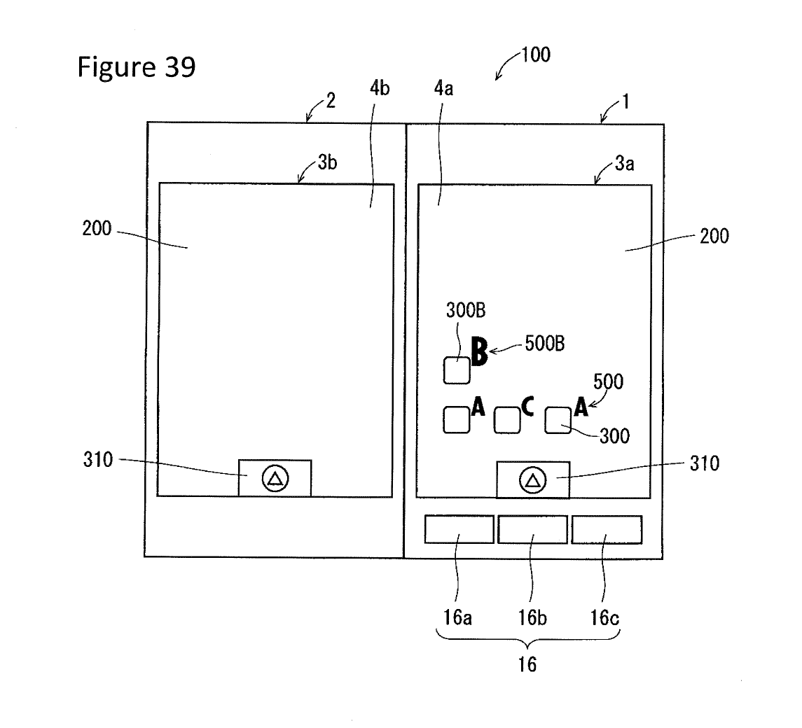

As with the abovementioned Embodiment 1 and the second variation, when a startup instruction operation is performed on one of the icons 300B for type B startup shown on the home screen 200, the startup method of the application 130 associated with the icon 300B for type B startup may be selected then. FIG. 38 and FIG. 39 are diagrams showing example displays of the mobile phone according to a variation of Embodiment 2 in such a case. In the home screen 200, together with the icons 300, the identification information 500 for identifying the respective types of the applications 130 associated with the icons 300 is shown. Then, for the icons 300B for type B startup, the display mode of the associated type B identification information 500B is changed over time between multiple display modes associated with each of the multiple startup methods of the applications 130 associated with the icons 300B for type B startup.

When a startup instruction operation is performed on one of the icons 300B for type B startup shown on the home screen 200, the application 130 associated with the icon 300B for type B startup is started up with the startup method corresponding to the display mode at the time of the type B identification information 500B associated with the icon 300B for type B startup. In FIG. 38, the type B identification information 500B is shown being displayed in the display mode associated with the one-screen startup method. FIG. 39 shows the type B identification information 500B shown in the home screen 200 displayed in the display mode associated with the two-screen startup method.

<Third Variation>

As with the above Embodiment 1 and the third variation, when the user starts up one of the applications 130 of type B with a startup method in which only one of the display screens 4 is used for the execution of the application 130, they may be able to select the display screen 4 used from among the first display screen 4a and the second display screen 4b. In this case, the display mode of the type B identification information 500B repeatedly and sequentially changes in the order of the abovementioned display mode associated with the first one-screen startup method, the display mode associated with the second one-screen startup method, and the display mode associated with the two-screen startup method.

Then, when the type B identification information 500B is displayed in the display mode associated with the first one-screen startup method in the application list screen 210, if the user uses their finger 400 and taps one of the icons 300B for type B startup associated with the type B identification information, the application 130 of type B associated with the icon 300B for type B startup is started up with the first one-screen startup method. Moreover, when the type B identification information 500B is displayed in the display mode associated with the second one-screen startup method in the application list screen 210, if the user uses their finger and taps one of the icons 300B for type B startup associated with the type B identification information 500B, the application 130 of type B associated with the icon 300B for type B startup is started up with the second one-screen startup method.

Then, when the type B identification information 500B is displayed in the display mode associated with the two-screen startup method in the application list screen 210, if the user uses their finger and taps one of the icons 300B for type B startup associated with the type B identification information 500B, the application 130 of type B associated with the icon 300B for type B startup is started up with the two-screen startup method.

For example, for the type B identification information 500 displayed in the display mode associated with the first one-screen startup method, the size is small, and for the type B identification information 500 displayed in the display mode associated with the second one-screen startup method, the size is medium-sized, and for the type B identification information 500B displayed in the display mode associated with the two-screen startup method, the size is large.

<Fourth Variation>

For the applications 130 of type A that are started up with only the one-screen startup method, they may be started up with the first one-screen startup method, in which only the first display screen 4a is used, and the second one-screen startup method, in which only the second display screen 4b is used. In this case, the display mode of the identification information 500 for identifying the respective types of the applications 130 that is displayed together with the icons 300 for starting up the applications 130 of type A alternates between the display mode associated with the first one-screen startup method and the display mode associated with the second one-screen startup method.

Then, when the identification information 500 displayed together with one of the icons 300 associated with one of the applications 130 of type A is displayed in the display mode associated with the first one-screen startup method, if a startup instruction operation is performed on the icon 300, the application 130 of type A is started up with the first one-screen startup method. When the identification information 500 displayed together with one of the icons 300 associated with one of the applications 130 of type A is displayed in the display mode associated with the second one-screen startup method, the application 130 of type A is started up with the second one-screen startup method.

<Fifth Variation>

In the above example, when changing the display mode of the type B identification information 500B in associated with the startup methods, the size of the type B identification information 500B is changed, but the display mode of the type B identification information 500B may be changed using another method.

For example, as with the changes in the display mode of the icons 300B for type B startup in the abovementioned Embodiment 1 and the fourth variation, the color of the type B identification information 500B may be changed in association with the startup methods, or the outlines of the type B identification information 500B may be changed using dissimilar shapes in association with the startup methods. Moreover, the type B identification information 500B may be rotated in association with the startup methods.

<Sixth Variation>

In the above example, when the application list screen 210 is displayed on the mobile phone 100, the display mode of the type B identification information 500B is changed automatically, but the display mode of the type B identification information 500B associated with the icons 300B for type B startup may be changed only after the user selects one of the icons 300B for type B startup.

For example, when the application list screen 210 is displayed on the mobile phone 100, the type B identification information 500B is first displayed in the same display mode as the display mode associated with the one-screen startup method. Then, when the user performs a selection operation on one of the icons 300B for type B startup, the display mode of the type B identification information 500B associated with the icon 300B for type B startup is alternated between the display mode associated with the one-screen startup method and the display mode associated with the two-screen startup method. The selection operation performed on the icon 300B for type B startup may be, for example, an operation in which the icon 300B for type B startup is touched with a finger. In other words, when the user touches the icon 300B for type B startup with their finger, animated display of the type B identification information associated with the icon 300B for type B startup is started and the display mode changes.

After performing the selection operation on one of the icons 300B for type B startup, if the user performs a startup instruction operation on the icon 300B for type B startup, the application 130 associated with the icon 300B for type B startup is started up with the startup method corresponding to the display mode of the type B identification information 500B associated with the icon 300B for type B started at the time when the startup instruction operation was performed. The startup instruction operation performed on the icon 300B for type B startup may be, for example, an operation in which the finger touching the icon 300B for type B startup when selecting the icon 300B for type B startup is released from the icon 300B for type B startup.

In other words, during the period when the user is touching the icon 300B for type B startup with their finger, the display mode of the type B identification information 500B associated with the icon 300B for type B startup changes, and when the user releases their finger from the icon 300B for type B startup, the application 130 associated with the icon 300B for type B startup is started up with the startup method corresponding to the display mode of the type B identification information 500B at that time.

Furthermore, in the abovementioned third variation of Embodiment 2 as well, the display mode of the type B identification information 500B associated with the icons 300B for type B startup may be changed only after the user selects one of the icons 300B for type B startup.

<Seventh Variation>

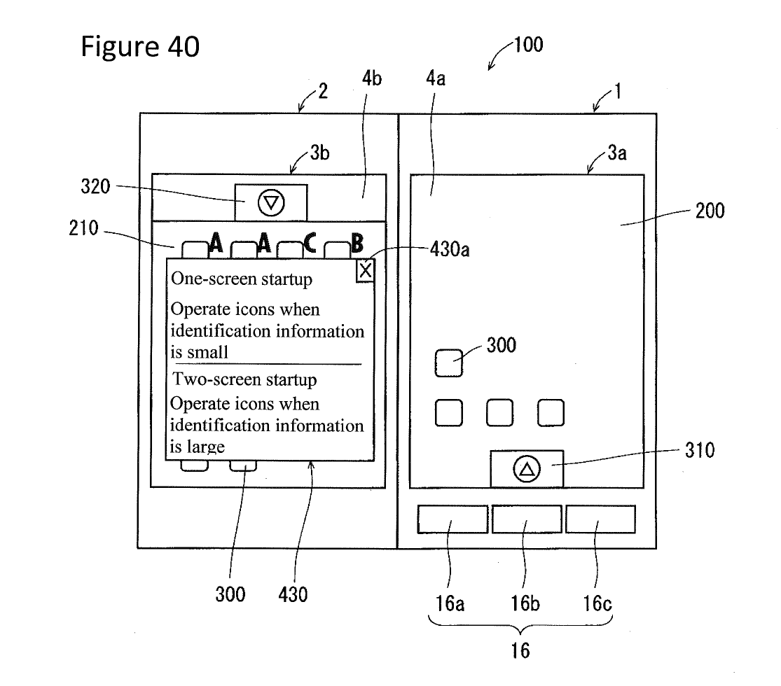

As with the abovementioned seventh variation of Embodiment 1, a help screen showing methods of starting up the applications 130 of type B with each startup method may be displayed. In this case, the Display button 410 for displaying the help screen is displayed on the application list screen 210. Then, when the user operates the Display button 410, as shown in FIG. 40, a help screen 430 is displayed over the application list screen 210. FIG. 40 is a diagram showing an example display of the mobile phone according to a variation of Embodiment 2.

On the help screen 430, methods of starting up the applications 130 of type B with the one-screen startup method and the two-screen startup method are shown. On the help screen 430, a button 430a for closing the screen is shown. When the button 430a is operated, the help screen 420 is no longer displayed.

Furthermore, as in the above fourth variation of Embodiment 2, if the applications 130 of type A can be started up with multiple startup methods, methods of starting up using each of the multiple startup methods may be displayed in the help screen 430.

### Embodiment 3

In the abovementioned Embodiment 1, because it is possible to start up the applications 130 of type B with multiplied startup methods using the same startup instruction operation on the icons 300B for type B startup, the display modes of the icons 300B for type B startup are changed in accordance with the startup methods. In the present embodiment, without changing the display modes of the icons 300B for type B startup, by performing a different startup instruction operation on the icons 300B for type B startup, it is possible to start up the applications 130 of type B with multiple startup methods. The following is a description of the mobile phone 100 according to the present embodiment, focusing on differences with the mobile phone 100 according to the abovementioned Embodiment 1.

In the present embodiment, as startup instruction operations performed on the icons 300B for type B startup, a one-screen startup instruction operation associated with the one-screen startup method and a two-screen startup instruction operation associated with the two-screen startup method are defined. When the one-screen startup instruction operation is performed on one of the icons 300B for type B startup shown on the application list screen 210, the application 130 associated with the icon 300B for type B startup is started up with the one-screen startup method. When the application 130 is started up with the one-screen startup method, as with Embodiment 1, the display screen 4 on which the one-screen startup operation was performed when starting up the application 130 is used for the execution of the application 130 from among the first display screen 4a and the second display screen 4b.

On the other hand, when the two-screen startup instruction operation is performed on one of the icons 300B for type B startup shown on the application list screen 210, the application 130 associated with the icon 300B for type B startup is started up with the two-screen startup method.

For the combinations of the one-screen startup instruction operation and two-screen startup instruction operation, various combinations may be used. For example, an operation in which one of the icons 300B for type B startup is tapped once (single tap) is defined as the one-screen startup instruction operation, and an operation in which the icon 300B for type B startup is tapped twice continuously (double tap) is defined as the two-screen startup instruction operation.

Alternatively, a tap on one of the icons 300B for type B startup is defined as the one-screen startup instruction operation, and an operation in which, while touching the icon 300B for type B startup with a finger, the display screen 4 that is not the display screen 4 on which the icon 300B for type B startup is displayed is touched with another finger is defined as the two-screen startup instruction operation.

In this way, in the present embodiment, when a startup instruction operation is performed on one of the icons 300B for type startup, the application 130 associated with the icon 300B for type B startup is started up with the startup method corresponding to the startup instruction operation. Consequently, by selecting the startup instruction operation to be performed on one of the icons 300B for type B startup, the user is able to select the display screen 4 that is used for the execution of the application 130 associated with the icon 300B for type B startup. As a result, it is possible to prevent the use of the display screen 4 that the user does not wish to use when starting up the applications 130 of type B.

### Variations of Embodiment 3

The following are descriptions of various variations of Embodiment 3.

<First Variation>

As with the abovementioned first variations of Embodiments 1 and 2, for the applications 130 of type A or type B, after the startup of one of the applications 130, the user may be able to change the display screen 4 used for the execution of the application 130 by, for example, operating the first operation module 16.

<Second Variation>

In the above example, as startup instruction operations performed on the icons 300B for type B startup shown on the application list screen 210, multiple startup instruction operations associated with the multiple startup methods are defined, but multiple startup instruction operations associated with the multiple startup methods may be defined as startup instruction operations performed on the icons 300B for type B shown on the home screen 200. In this case, when the one-screen startup instruction operation is performed on one of the icons 300B for type B startup shown on the home screen 200, the application 130 associated with the icon 300B for type B startup is started up with the one-screen startup method. Moreover, when the two-screen startup instruction operation is performed on one of the icons 300B for type B startup shown on the home screen 200, the application 130 associated with the icon 300B for type B startup is started up with the two-screen startup method.

<Third Variation>

In the above example, when starting up one of the applications 130 of type B with the one-screen startup method, the user is unable to select the display screen 4 used for the execution of the application 130, but they may be able to make such a selection. In this case, as startup instruction operations performed on the icons 300B for type B startup, a first one-screen startup instruction operation associated with the abovementioned first one-screen startup method, a second one-screen startup instruction operation associated with the second one-screen startup method, and a two-screen startup instruction operation associated with the two-screen startup method are defined.

Then, when the first one-screen startup instruction operation is performed on one of the icons 300B for type B startup in the application list screen 210, the application 130 associated with the icon 300B for type B startup is started up with the first one-screen startup method. When the application 130 is started up with the first one-screen startup method, only the first display screen 4a is used for the execution of the application 130.

When the second one-screen startup instruction operation is performed on one of the icons 300B for type B startup, the application 130 associated with the icon 300B for type B startup is started up with the second one-screen startup method. When the application 130 is started up with the second one-screen startup method, only the second display screen 4b is used for the execution of the application 130.

When the two-screen startup instruction operation is performed on one of the icons 300B for type B startup, the application 130 associated with the icon 300B for type B startup is started up with the two-screen startup method. When the application 130 is started up with the two-screen startup method, both the first display screen 4a and the second display screen 4b are used for the execution of the application 130.

For combinations of the first one-screen startup instruction operation and the second one-screen startup instruction operation, various combinations may be used.

For example, a double tap performed on one of the icons 300B for type B startup is defined as the two-screen startup instruction operation. For the icons 300B for type B startup displayed on the first display screen 4a, a tap on one of the icons 300B for type B startup is defined as the first one-screen startup instruction operation, and an operation in which the icon 300B for type B startup is flicked toward the second display screen 4b with a finger is defined as the second one-screen startup instruction operation. For the icons 300B for type B startup displayed on the second display screen 4b, a tap on one of the icons 300B for type B startup is defined as the second one-screen startup instruction operation, and an operation in which the icon 300B for type B startup is flicked toward the first display screen with a finger is defined as the first one-screen startup instruction operation. Operations in which the finger is flicked over the screen are referred to as “flicks”.

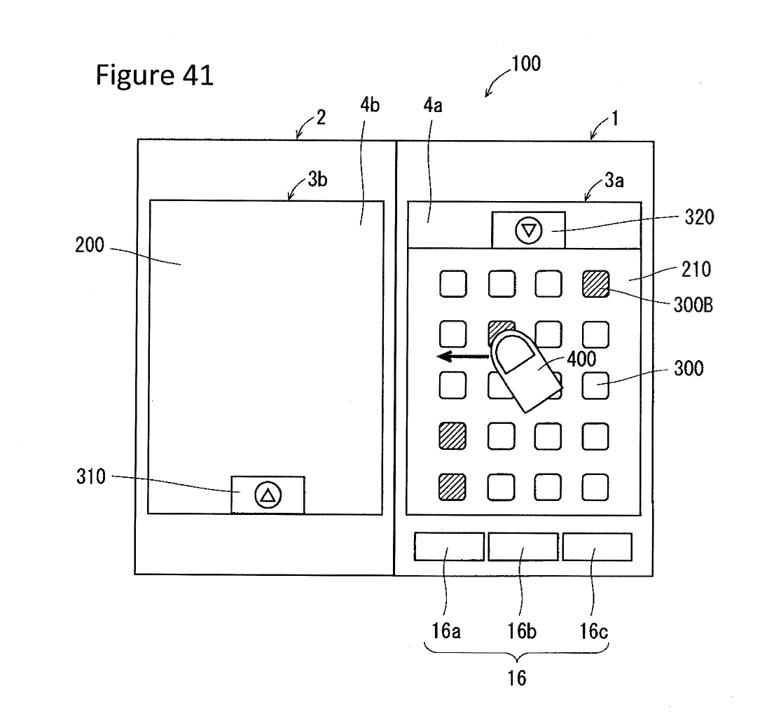

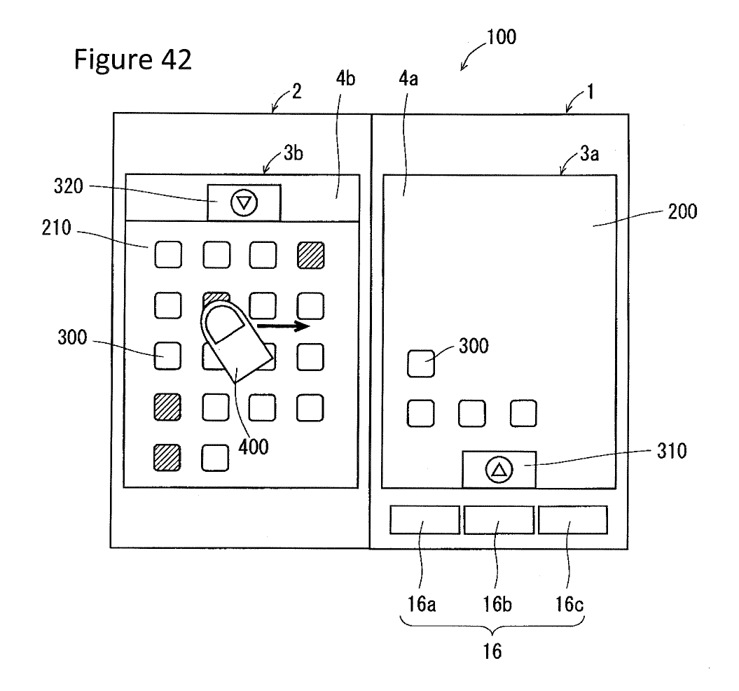

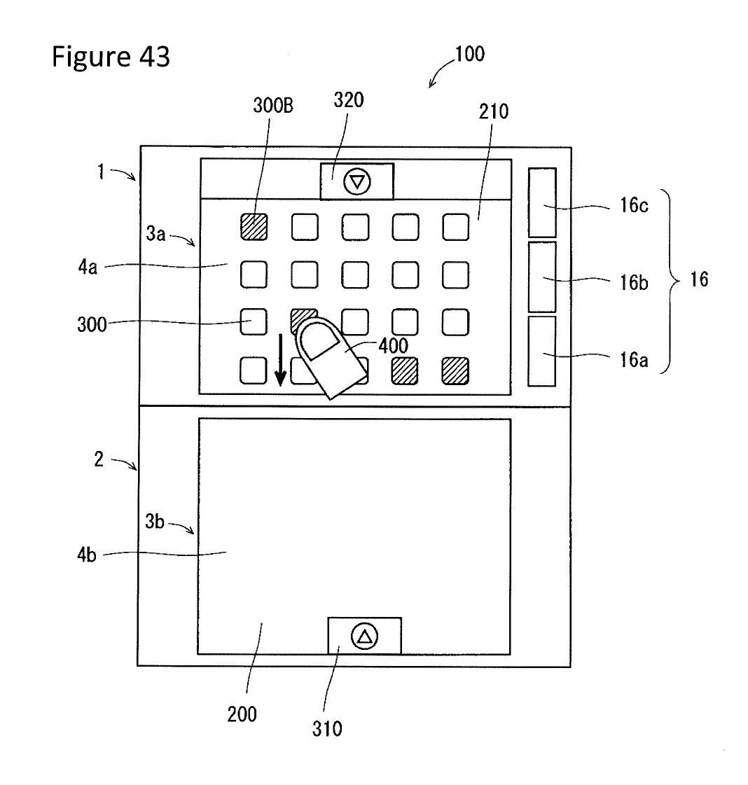

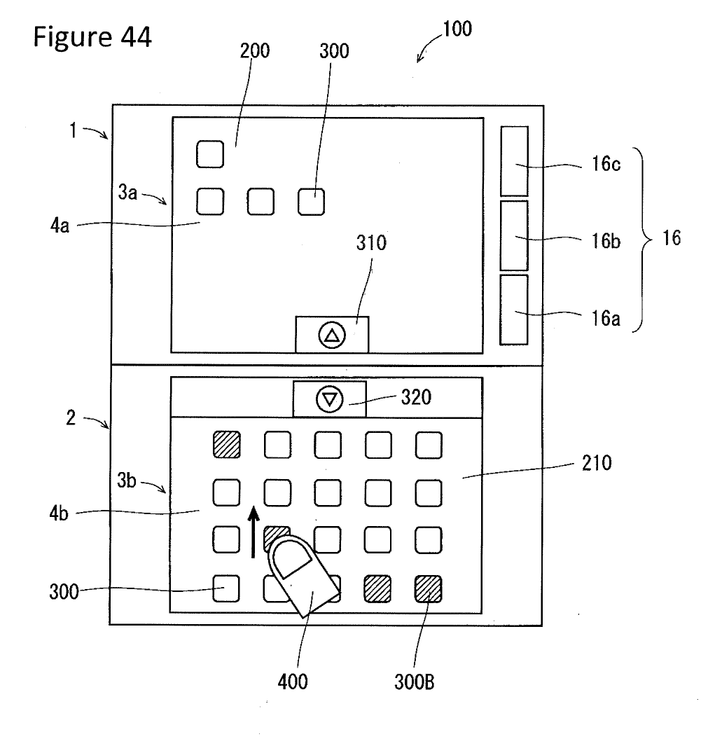

FIG. 41-44 are diagrams showing flicks being performed on the icons 300B for type B startup. For the icons 300B for type B startup displayed on the first display screen 4a of the mobile phone 100 in a horizontal open state with the first display screen 4a on the right side, a flicking operation with the finger 400 in the leftward direction (toward the second display screen 4b) (leftward flick) is the second one-screen startup instruction operation. For the icons 300B for type B startup displayed on the second display screen 4b of the mobile phone 100 in a horizontal open state with the first display screen 4a on the right side, a flicking operation with the finger 400 in the rightward direction (toward the first display screen 4a) (rightward flick) is the first one-screen startup instruction operation.

Moreover, for the icons 300B for type B startup displayed on the first display screen 4a of the mobile phone 100 in a vertical open state with the first display screen 4a on top, a downward flicking operation with the finger 400 (toward the second display screen 4b) (downward flick) is the second one-screen startup instruction operation. For the icons 300B for type B startup displayed on the second display screen 4b of the mobile phone 100 in a vertical open state with the first display screen 4a on top, an upward flicking operation with the finger 400 (toward the first display screen 4a) (upward flick) is the first one-screen startup instruction operation.

In this way, in the present example, because it is possible to start up the applications 130 of type B with the first one-screen startup method, in which only the first display screen 4a is used, and the second one-screen startup method, in which only the second display screen 4b is used, the user is able to execute the applications 130 of type B using only the desired display screen 4 from among the first display screen 4a and the second display screen 4b.

Moreover, in the present example, if a flicking operation (flick) is performed with a finger on one of the icons 300B for type B startup as an operation issuing an instruction for the startup of the application 130 associated with the icon 300B for type B startup, only the display screen 4 positioned in the direction of the flick (flicking direction) is used for the execution of the application 130. Consequently, it is easy for the user to intuitively select the display screen 4 used for execution when starting up the application 130.

<Fourth Variation>

As with the fourth variations of the above Embodiments 1 and 2, for the applications 130 of type A that are started up with only the one-screen startup method, they may also be started up with the first one-screen startup method, in which only the first display screen 4a is used, and the second one-screen startup method, in which only the second display screen 4b is used. In this case, as startup instruction operations performed on the icons 300 for starting up the applications 130 of type A (hereinafter also referred to as “icons 300 for type A startup”), a first one-screen startup instruction operation associated with the first one-screen startup method and a second one-screen startup instruction operation associated with the second one-screen startup method are defined.

When the first one-screen startup instruction operation is performed on one of the icons 300 associated with one of the applications 130 of type A, the application 130 of type A is started up with the first one-screen startup method. When the second one-screen startup instruction operation is performed on one of the icons 300 associated with one of the applications 130 of type A, the application 130 of type A is started up with the second one-screen startup method.

For the combination of the first one-screen startup operation and second one-screen startup operation performed on the icons 300 for type A startup, various combinations may be used.

For example, for the icons 300 for type A startup displayed on the first display screen 4a, a tap performed on one of the icons 300 for type A startup is defined as the first one-screen startup instruction operation, and an operation in which the icon 300 for type A startup is flicked with a finger toward the second display screen 4b is defined as the second one-screen startup instruction operation. For the icons 300 for type A startup displayed on the second display screen 4b, a tap performed on one of the icons 300 for type A startup is defined as the second one-screen startup instruction operation, and an operation in which the icon 300 for type A startup is flicked with a finger toward the first display screen 4a is defined as the first one-screen startup instruction operation.

In this way, for the applications 130 of type A as well, by making it possible to select the display screen 4 used for execution during startup, it is possible to prevent the use of the display screen 4 that the user does not wish to use when starting up the applications 130 of type A.

If a flicking operation (flick) using a finger is performed on one of the icons 300 for type A startup as an operation issuing an instruction to start up the application 130 associated with the icon 300 for type A startup, because only the display screen 4 positioned in the direction of the flick (flicking direction) is used for the execution of the application 130, it is easy for the user to intuitively select the display screen 4 to be used for execution when starting up the application 130.

<Fifth Variation>

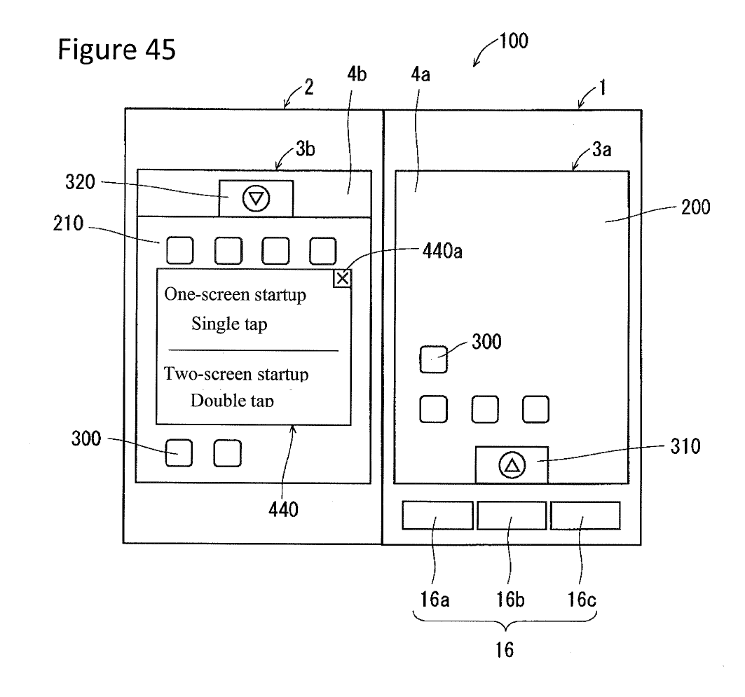

As with the abovementioned seventh variation of Embodiment 1, a help screen showing methods of starting up the applications 130 of type B with each startup method may be displayed. In this case, A Display button 410 for displaying the help screen is displayed on the application list screen 210. FIG. 45 is a diagram showing an example display of the mobile phone according to a variation of Embodiment 3 when the user operates the Display button 410. The help screen 440 is displayed over the application list screen 210.

The help screen 440 shows methods of starting up the applications 130 of type B with the one-screen startup method and the two-screen startup method. The help screen 440 also shows a button 440a for closing the screen. When the button 440a is operated, the help screen 440 is no longer displayed.

If, as in the above fourth variation of Embodiment 3, the applications 130 of type A may be started up with multiple startup methods, methods of starting up with each of the multiple startup methods may be displayed on the help screen 440.

### Variations common to Embodiments 1-3

The following are descriptions of variations common to the abovementioned Embodiments 1 through 3 and the variations thereof.

<First Common Variation>

When the mobile phone 100 changes from the open state to the closed state, the control module 12 may change the applications 130 of type B that can be started up with both the one-screen startup method and the two-screen startup method into the applications 130 of type A that can be started up with only the one-screen startup method. When the mobile phone 100 is in the closed state, if one of the applications 130 of type A is started up, only the visible first display screen 4a is used for the execution of the application 130.

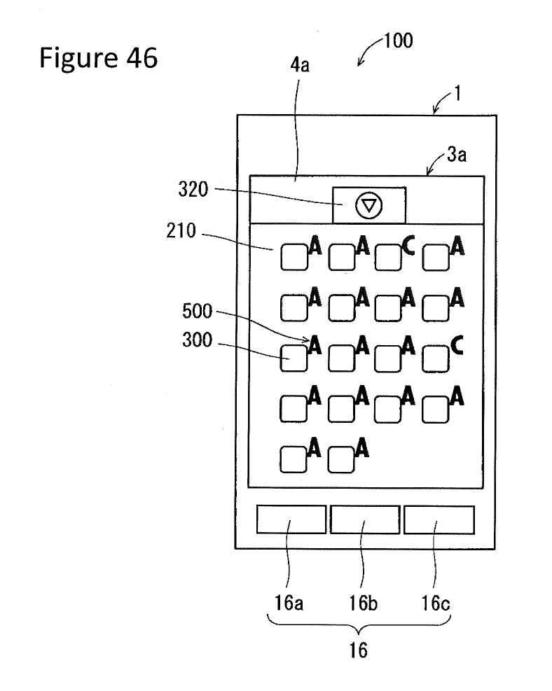

In the abovementioned Embodiment 2, when the mobile phone 100 has changed from the open state to the closed state, if the applications 130 of type B are changed to the applications 130 of type A, the identification information 500 displayed together with the icons 300 associated with the applications 130 is changed from information indicating type B to information indicating type A. FIG. 46 is a diagram showing an example display of the mobile phone according to a variation of Embodiment 2. Specifically, FIG. 46 is a diagram showing an example display of the mobile phone 100 after the mobile phone 100 displayed in the abovementioned FIG. 34 is changed from the open state to the closed state.

When the mobile phone 100 is changed from the open state to the closed state, the application list screen 210 displayed on the second display screen 4b is displayed on the visible first display screen 4a. Then, the applications 130 of type B are changed to the applications 130 of type A, and in accordance with this change in type, the identification information 500 shown next to the icons 300 associated with the applications 130 is changed.

The applications 130 changed from type B to type A when the mobile phone 100 changes from the open state to the closed state return to type B when the mobile phone 100 returns to the open state.

<Second Common Variation>

If the mobile phone 100 changes from the open state to the closed state, the control module 12 may change the applications 130 of type B that can be started up with both the one-screen startup method and two-screen startup method into the applications of type C that can be started up with only the two-screen startup method.

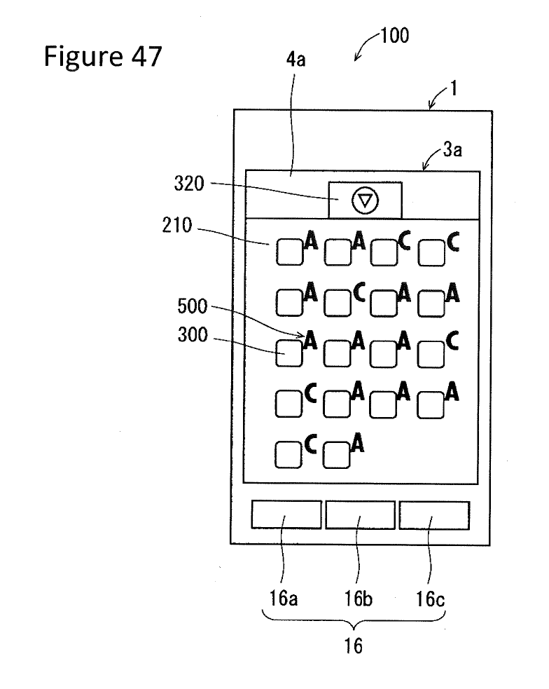

In the abovementioned Embodiment 2, when the mobile phone 100 has changed from the open state to the closed state, if the applications 130 of type B are changed to the applications 130 of type C, the identification information 500 displayed together with the icons 300 associated with the applications 130 are changed from information indicating type B to information indicating type C. FIG. 47 is a diagram showing an example display of the mobile phone according to a variation of Embodiment 2. Specifically, FIG. 47 is a diagram showing an example display of the mobile phone 100 after the mobile phone 100 has changed from the open state to the closed state.

When the mobile phone 100 changes from the open state to the closed state, the application list screen 210 displayed on the second display screen 4b is displayed on the visible first display screen 4a. Then, the applications 130 of type B are changed to the applications of type C, and in accordance with this change in type, the identification information 500 shown next to the icons 300 associated with the applications 130 is changed.

The applications 130 changed from type B to type C when the mobile phone 100 changes from the open state to the closed state return to type C when the mobile phone 100 returns to the open state.

<Third Common Variation>

When the mobile phone 100 is in the closed state, because only the first display screen 4a is visible from among the first display screen 4a and the second display screen 4b, even if one of the applications 130 of type C is started up with the two-screen startup method, in this state, the user is unable to view the content displayed on the second display screen 4b.

Therefore, in the present variation, when the mobile phone 100 is in the closed state, if a startup instruction operation is performed on an icon associated with one of the applications 130 of type C (hereinafter also referred to as an “icon 300 for type C startup”) that is displayed on the first display screen 4a, instead of immediately starting up the application 130 of type C, the application 130 of type C is started up after the mobile phone 100 changes from the closed state to the open state.

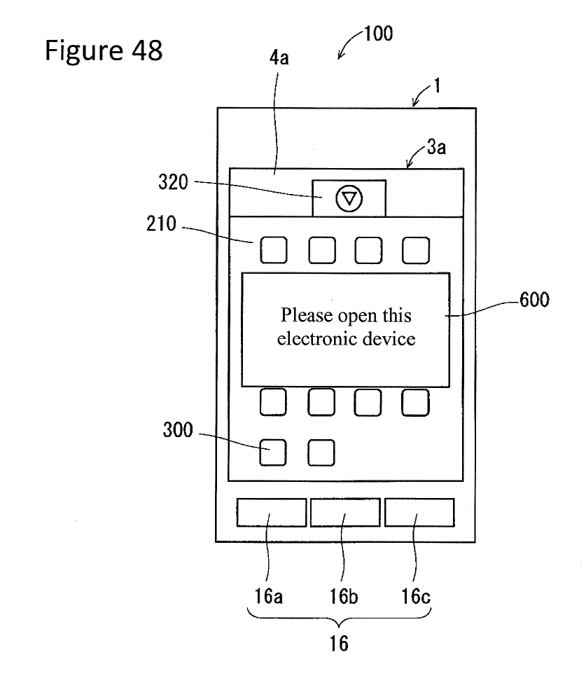

In the present variation, when a startup instruction operation is performed on one of the icons 300 for type C startup, it is desirable to display notification information 600 providing notification to change the mobile phone 100 from the closed state to the open state on the first display screen 4a. FIG. 48 is a diagram showing an example display on the mobile phone according to a common variation of Embodiments 1 through 3.

<Fourth Common Variation>

The mobile phone 100 may be configured to allow the display of one of either the first display screen 4a or the second display screen 4b to be turned off. If the display module 3 is, for example, a backlit liquid crystal display module, the display of the display screen 4 may be turned off as a result of the control module 12 stopping the emission of the backlight illuminating the display screen 4 of the display module 3.

In the mobile phone 100 in the open state, the user may be able to arbitrarily select the display screen 4 to turn off the display on from among the first display screen 4a and the second display screen 4b by operating one of either the first display screen 4a or the second display screen 4b. When the mobile phone 100 changes from the open state to the closed state, the display of the second display screen 4b that is not visible may be turned off automatically.

If the display of one of either the first display screen 4a or the second display screen 4b is turned off, in this state, it is not possible to use both the first display screen 4a and the second display screen 4b for the execution of the applications 130. In such a case, when an attempt is made to startup one of the applications 130 of type B or type C with the two-screen startup method, a message indicating that startup is not possible is displayed on the display screen 4 on which the display is not turned off. Alternatively, notification information providing notification to turn on the display of both of the display screens 4 is displayed on the display screen 4 on which the display is not turned off, and when both of the display screens 4 is turned on, the application 130 is started up with the two-screen startup method.

If the display of one of either the first display screen 4a or the second display screen 4b is turned off, as in the abovementioned second common variation, the applications 130 of type B may be changed to the applications 130 of type B. In the abovementioned Embodiment 2, when changing the applications 130 of type B to the applications 130 of type A, the identification information 500 displayed together with the icons 300 associated with the applications 130 is changed to information indicating type B to information indicating type A.

<Fifth Common Variation>

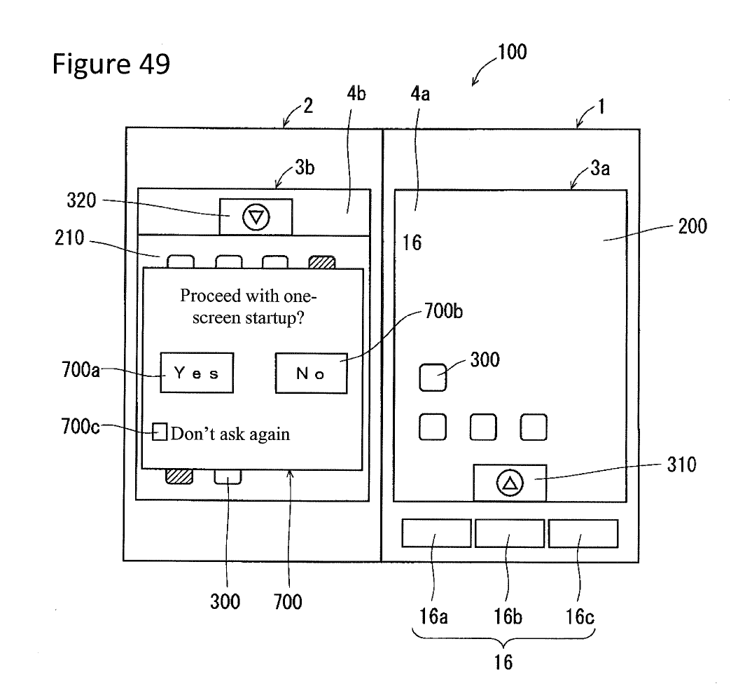

When the user attempts to start up one of the applications 130 of type B with a certain startup method, a confirmation screen that confirms with the user whether the application 130 may be started up with the startup method may be displayed. FIG. 49 is a diagram showing an example display of the mobile phone according to a variation of Embodiment 1. Specifically, FIG. 49 is a diagram showing an example of a confirmation screen 700 displayed when the user attempts to start up one of the applications 130 of type B with the one-screen startup method. In FIG. 49, the confirmation screen 700 is shown on the mobile phone 100 according to the abovementioned Embodiment 1, but the confirmation screen 700 may also be displayed on the mobile phone 100 according to the abovementioned Embodiments 2 and 3.

When the user performs a startup instruction operation on one of the icons 300B for type B startup to start up the application 130 associated with the icon 300B for type B startup with the one-screen startup method, the confirmation screen 700 for confirming with the user whether startup may be performed with the one-screen startup method is displayed. On this confirmation screen 700, a Yes notification button 700a for notifying the mobile phone 100 that startup may be performed with the one-screen startup method is shown, and a No notification button 700b for notifying the mobile phone 100 that startup should not be performed with the one-screen startup method is shown. Moreover, a check button 700c for providing permission to no longer display this screen in the future is shown on the confirmation screen 700.

If the Yes notification button 700a is operated, the application 130 associated with the icon 300B for type B startup on which the startup instruction operation was performed is started up with the one-screen startup method. On the other hand, if the No notification button 700b is operated, the application 130 associated with the icon 300B for type B startup on which the startup instruction operation was performed is not started up, and the confirmation screen 700 is no longer displayed. If the check button 700c is operated and either the Yes notification button 700a or the No notification button 700b is operated with the check button 700c checked, the confirmation screen 700 is no longer displayed even when a startup instruction operation is performed on one of the icons 300B for type B startup to start up the application 130 associated with the icon 300B for type B startup with the one-screen startup method.

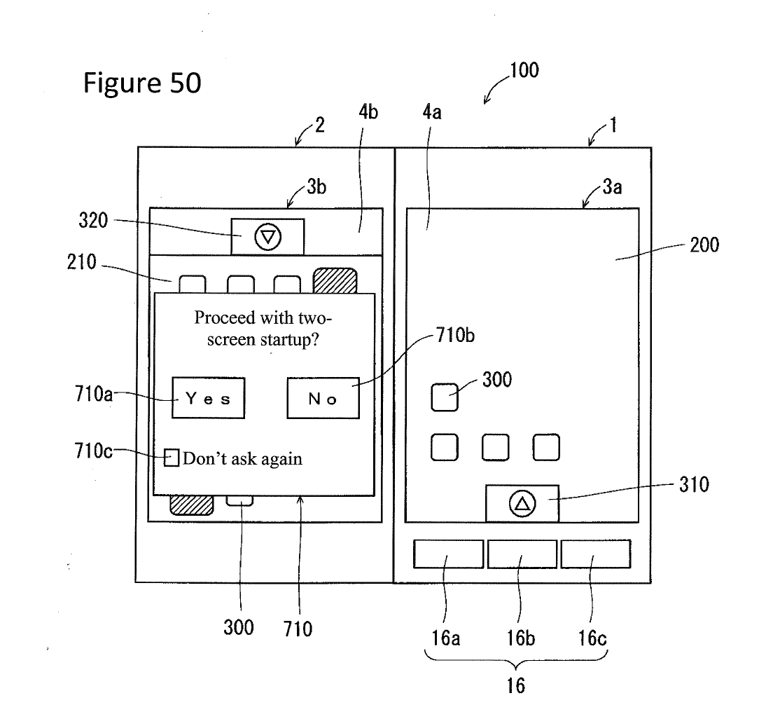

FIG. 50 is a diagram showing an example display of the mobile phone according to a variation of Embodiment 1. Specifically, FIG. 50 is a diagram showing an example of the confirmation screen 710 displayed when the user attempts to start up one of the applications 130 of type B with the two-screen startup method. In FIG. 50, the confirmation screen 710 is shown on the mobile phone 100 according to the abovementioned Embodiment 1, but the confirmation screen 700 may also be displayed on the mobile phone 100 according to the abovementioned Embodiments 2 and 3.

When the user performs a startup instruction operation on one of the icons 300B for type B startup to start up the application 130 associated with the icon 300B for type B startup with the two-screen startup method, a confirmation screen 710 confirming with the user whether startup may be performed with the two-screen startup method is displayed. On this confirmation screen 710, a Yes notification button 710a for notifying the mobile phone 100 that startup may be performed with the two-screen startup method is shown, and a No notification button 710a for notifying the mobile phone 100 that startup should not be performed with the two-screen startup method is shown. Moreover, a check button 710c for providing permission to no longer display this screen in the future is shown on the confirmation screen 710.

If the Yes notification button 710a is operated, the application 130 associated with the icon 300B for type B startup on which the startup instruction operation was performed is started up with the two-screen startup method. On the other hand, if the No notification button 710b is operated, the application 130 associated with the icon 300B for type B startup on which the startup instruction operation was performed is not started up, and the confirmation screen 710 is no longer displayed. If the check button 710c is operated and either the Yes notification button 710a or the No notification button 710b is operated with the check button 710c checked, the confirmation screen 710 is no longer displayed even when a startup instruction operation is performed on one of the icons 300B for type B startup to start up the application 130 associated with the icon 300B for type B startup with the two-screen startup method.

Furthermore, if the applications 130 of type A can be started up with multiple startup methods as in the above fourth variations of Embodiments 1 through 3, when an attempt is made to start up one of the applications 130 of type A with a certain startup method, a confirmation screen confirming with the user whether the application 130 may be started up with the startup method may be displayed.

<Sixth Common Variation>

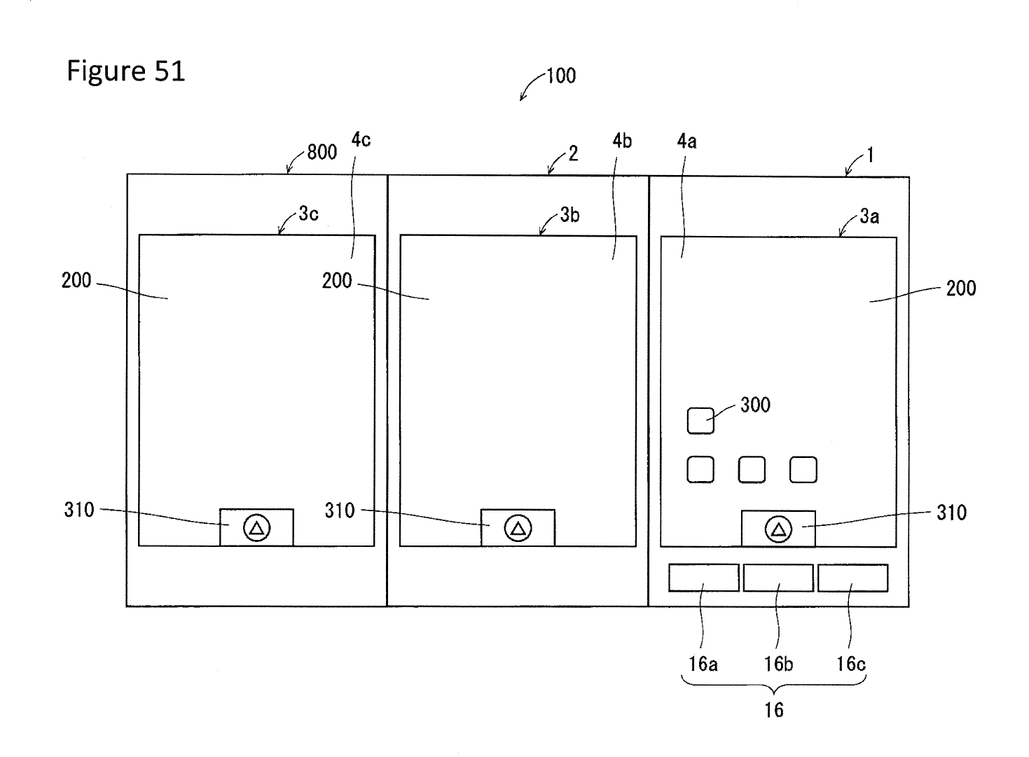

In the above example, the mobile phone 100 is a mobile phone comprising two display screens, but it may be a mobile phone that comprises three or more display screens and is used in modes in which the three or more display screens are all visible simultaneously. FIG. 51 is a diagram showing the configuration of a mobile phone according to common variation of Embodiments 1 through 3. Specifically, FIG. 51 is a diagram showing the mobile phone 100 that is further provided with a third display module 3c.

The third display module 3c is provided with a third chassis 800 connected to the second chassis 2. In the example display of FIG. 51, the home screen 200 is displayed across the first display screen 4a, the second display screen 4b, and a third display screen 4c of the third display module 3c. The Display button 310 is also shown on the part of the home screen 200 displayed on the third display module 3c. When the Display button 310 displayed on any one of the first display module 3a, the second display module 3b, or the third display module 3c is operated, the application list screen 210 is displayed on the display module on which the Display button 310 was operated.

In this way, if the mobile phone 100 comprises three display screens that are visible simultaneously, the types of the applications 130 may comprise, for example, the following types.

The first type is a type that is started up with only the one-screen startup method. The second type is a type that is started up with only the two-screen startup method. The third type is a type that is started up with only a startup method in which the three display screens are used for the execution of the application 130 (hereinafter referred to as the “three-screen startup method”). The fourth type is a type that can be started up with the one-screen startup method and the two-screen startup method. The fifth type is a type that can be started up with the one-screen startup method, the two-screen startup method, and the three-screen startup method.

For the applications 130 of the fourth type, as with the abovementioned applications 130 of type B, the startup method may be selectable at the time of the startup of the application 130.

Moreover, for the applications 130 of the fifth type as well, the startup method may be selected at the time of the startup of the application 130. For example, as with Embodiment 1, the display mode of the icon 300 for starting up the application 130 is changed in association with the startup methods. Then, when a startup instruction operation is performed on the icon 300, the application 130 associated with the icon 300 is started up with the startup method associated with the display mode of the icon 300 at that time.

Moreover, as with Embodiment 2, the display mode of the identification information 500 displayed together with the icons 300 associated with the applications 130 of the fifth type is changed in association with the startup methods. Then, when a startup instruction operation is performed on one of the icons 300, the application 130 associated with the icon 300 is started up with the startup method associated with the display mode of the identification information 500 next to the icon 300 at that time.

Moreover, as with Embodiment 3, as startup instruction operations performed on the icons 300 associated with the applications 130 of the fifth type, multiple startup instruction operations associated with the multiple startup methods of the applications 130 are defined. Then, when a startup instruction operation is performed on one of the icons 300, the application 130 associated with the icon 300 is started up with the startup method associated with the startup instruction operation.

In this way, embodiments of the disclosure can be applied to mobile phones used in modes in which three or more display screens are visible simultaneously.

Moreover, embodiments of the disclosure may also be applied to mobile phones in which, unlike the abovementioned mobile phone 100, multiple display screens are always visible simultaneously (i.e., mobile phones in which there is no closed state). Moreover, the embodiments of the disclosure may also be applied to a mobile phone in which multiple display screens are visible simultaneously in the open state and none of the multiple display screens are visible in the closed state. For example, embodiments of the disclosure may be applied to folding-type mobile phones or laptop computers in which two chassis can be folded over each other and in which display screens are formed on the inner surfaces of both chassis.

In this document, the terms “computer program product”, “computer-readable medium”, and the like may be used generally to refer to media such as, for example, memory, storage devices, or storage unit. These and other forms of computer-readable media may be involved in storing one or more instructions for use by the control module 12 to cause the control module 12 to perform specified operations. Such instructions, generally referred to as “computer program code” or “program code” (which may be grouped in the form of computer programs or other groupings), when executed, enable a method of operating the system 100.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a plurality of display modules simultaneously visible, and at least one of the display modules operable to display an icon for starting up an application program;
a memory operable to store a first application program for which startup is possible through a plurality of startup methods, each of the startup methods uses a respective display module for execution of the first application program from among the display modules;
a control module operable to display a first icon for starting up the first application program on the at least one of the display modules in a plurality of display modes respectively associated with the startup methods; and
an application-program execution module operable to start up the first application program using the startup methods associated with a display mode of the first icon in response to an operation issuing an instruction to start up the first application program associated with the first icon.

2. The mobile electronic device according to claim 1, wherein the display mode of the first icon changes over time between the display modes.

3. The mobile electronic device according to claim 1, wherein the control module is further operable to cause at least one of the display modules to simultaneously display the first icon in the display modes.

4. The mobile electronic device according to claim 1, wherein the display modes of the first icon comprises at least one of an outline of the first icon being different, a color of the first icon being different, and a position of the first icon being rotated.

5. A mobile electronic device comprising:
a plurality of display screens simultaneously visible, at least one of the display screens displays an icon for starting up an application program;
a memory operable to store a first type of application program for which startup is possible through a plurality of startup methods each of the methods use a different display module for an execution of the application program from among the display modules, and a plurality of startup instruction operations that are performed on a first icon for starting up the first type of application and that are respectively associated with the startup methods as operations issuing instructions to start up the first type of application; and
an application-program execution module operable to, start up the application program associated with the first program based on the startup method associated with the startup instruction operation, when a startup instruction operation is performed on the first icon.

6. The mobile electronic device according to claim 5, wherein the display screens further comprise a first display screen and a second display screen,
a first display module and a second display module comprising the first display screen and the second display screen respectively and each comprise a respective touch panel function,
the plurality of startup instruction operations comprising an operation in which the first icon is flicked with a finger toward one of: the first display screen and the second display screen, and
when flicking operation is performed on the first icon, the application-program execution module executes an application program using the display screen positioned in a direction in which the first icon is flicked in the flicking operation from among the first and second display screens.

7. The mobile electronic device according to claim 5, wherein the plurality of display screens further comprises a first display screen and a second display screen,
the mobile electronic device further comprises a first state in which the first and second display screens are visible simultaneously, and a second state in which only the first display screen is visible from among the first and second display screens,
the plurality of startup methods comprises a first startup method in which only one of the first and second display screen is used in an execution of the application program, and a second startup method in which both the first and second display screens are used in an execution of the application program, and
when the state of the mobile electronic device changes from the first state to the second state, the memory stores the first type of application program as a second type of application program for which startup is possible with only the first startup method from among the first and second startup methods.

8. The mobile electronic device according to claim 7, wherein
the plurality of display screens display an icon associated with the first type of application program together with identification information for identifying a type of application program associated with the icon, and
the mobile electronic device further comprises a control module operable to change the display mode of the identification information from a display mode indicating that the application is the first type of application to a display mode indicating that the application is the second type of application, when the device itself changes from the first state to the second state.

9. The mobile electronic device according to claim 5, wherein
the display screens further comprise a first display screen and a second display screen,
the mobile electronic device further comprises a first state in which the first and second display screens are visible simultaneously, and a second state in which only the first display screen is visible from among the first and second display screens,
the memory is further operable to store a second type of application program that is started up only with a startup method in which both the first and second display screens are used in an execution of an application program, and
when the mobile electronic device is in the second state, if an operation issuing an instruction to start up the application program associated with the icon is performed on an icon for starting up the second type of application program and then the mobile electronic device changes from the second state to the first state, the application-program execution module starts up the application program.

10. The mobile electronic device according to claim 9, wherein
when the mobile electronic device is in the second state, if an operation issuing an instruction to start up the application program associated with the icon is performed on an icon for starting up the second type of application program, the first display screen displays notification information providing notification that the mobile electronic device will be changed from the second state to the first state.

11. A method for operating a mobile electronic device, the method comprising:
displaying startup icon for starting an application program that starts through a plurality of startup methods each using a respective display module from among a plurality of display modules for execution of the application program;
displaying the startup icon on at least one of the display modules in at least one of a plurality of display modes respectively associated with the startup methods; and
starting the application program using a startup method among the startup methods associated with a display mode of the startup icon among the display modes in response to an operation issuing an instruction to start up the application program associated with the startup icon.

12. The method of claim 11, wherein the display mode of the startup icon changes over time between the display modes.

13. The method of claim 11, further comprising causing at least one of the display modules to simultaneously display the startup icon in the display modes.

14. The method of claim 11, wherein the display modes of the first icon comprise at least one of: a change of an outline of the startup icon, a color change of the startup icon, and a position rotation of the startup icon.

15. A computer readable storage medium comprising computer-executable instructions for operating a mobile electronic device, the method executed by the computer-executable instructions comprising:
displaying a startup icon for starting an application program that starts through a plurality of startup methods each using a respective display module from among a plurality of display modules for execution of the application program;
displaying the startup icon on at least one of the display modules in at least one of a plurality of display modes respectively associated with the startup methods; and
starting the application program using a startup method among the startup methods associated with a display mode of the startup icon among the display modes in response to an operation issuing an instruction to start up the application program associated with the startup icon.

16. The computer readable storage medium according to claim 15, the method executed by the computer-executable instructions further comprising:
changing the display mode of the startup icon over time between the display modes.

17. The computer readable storage medium according to claim 15, the method executed by the computer-executable instructions further comprising:
causing at least one of the display modules to simultaneously display the first icon in the display modes.

18. The computer readable storage medium according to claim 15, the method executed by the computer-executable instructions wherein:
the display modes of the first icon comprises at least one of: a change of an outline of the startup icon, a color change of the startup icon, and a position rotation of the startup icon.
